(19) United States
(12) Patent Application Publication
(10) Pub. No.: US 2024/0314290 A1
(43) Pub. Date: Sep. 19, 2024

(54) METHODS AND APPARATUS TO MODEL VOLUMETRIC REPRESENTATIONS

(71) Applicant: Intel Corporation, Santa Clara, CA (US)

(72) Inventors: David Israel Gonzalez Aguirre, Portland, OR (US); Javier Perez-Ramirez, North Plains, OR (US); Javier Felip Leon, Hillsboro, OR (US); Edgar Macias Garcia, Zapopan (MX); Julio Cesar Zamora Esquivel, West Sacramento, CA (US)

(21) Appl. No.: 18/521,937

(22) Filed: Nov. 28, 2023

(51) Int. Cl. H04N 13/388; G06T 17/00; H04N 23/69; H04N 23/695

(52) U.S. Cl. CPC H04N 13/388; G06T 17/00; H04N 23/69; H04N 23/695

(57) ABSTRACT

Example systems, apparatus, articles of manufacture, and methods to model volumetric representations of objects in scenes are disclosed. Example apparatus disclosed herein are to form a set of polycells from image data of a scene, a first one of the polycells based on an intersection of (a) a first polytope representative of at least a portion of a first view frustrum corresponding to a first camera, and (b) a second polytope representative of at least a portion of a second view frustrum corresponding to a second camera. Disclosed example apparatus is also to determine a probability that the first one of the polycells is at least partially within an object in the scene, and based on comparison of the probability to a threshold, remove the first one of the polycells from the set of polycells to determine an updated set of polycells that model the object.

### FIELD OF THE DISCLOSURE

This disclosure relates generally to image processing and, more particularly, to methods and apparatus to model volumetric representations.

### BACKGROUND

In recent years, the need for devices to quickly observe and interpret changing environments has risen. For example, applications including but not limited to smart cities, airports, high-ways, academic or business campuses, supermarkets, parking, factories, etc., can provide safety and functionality to their respective environments by identifying objects (e.g., humans, animals, vehicles, shopping carts, luggage, etc.) and monitoring the motion of said objects throughout the environment. Some applications may benefit from interpreting three dimensional (3D) models of an environment, which generally provide more contextual information than two dimensional representations.

### BRIEF DESCRIPTION OF THE DRAWINGS

FIG. 1 is a block diagram of an example system to model volumetric representations.

FIG. 2A is an illustrative example of an environment that implements the system of FIG. 1.

FIG. 2B represent example perspective views of the cameras of FIG. 2A.

FIG. 3 is a block diagram of an example implementation of the cameras and the server of FIG. 2A.

FIG. 4A is a block diagram of an example implementation of the segment creator circuitry of FIG. 3.

FIG. 4B is an illustrative example of operations performed by the segment creator circuitry as described in connection with FIG. 4A.

FIG. 5 is an illustrative example of a frustum generated by a camera.

FIG. 6 is an illustrative example of polytopes created by intersecting frustums.

FIG. 7A is a block diagram of an example implementation of the shape condenser circuitry of FIG. 3.

FIG. 7B is an illustrative example of operations performed by the shape condenser circuitry as described in connection with FIG. 7A.

FIG. 7C is an illustrative example of operations performed by the shape condenser circuitry as described in connection with FIG. 7A.

FIG. 8A is a block diagram of an example implementation of the model manager circuitry of FIG. 3.

FIG. 8B is an illustrative example of operations performed by the model manager circuitry as described in FIG. 8A.

FIG. 9 is a flowchart representative of example machine-readable instructions and/or example operations that may be executed, instantiated, and/or performed by example programmable circuitry to implement the clique of FIG. 2A.

FIG. 10 is a flowchart representative of example machine-readable instructions and/or example operations that may be executed, instantiated, and/or performed by example programmable circuitry to implement the segment creator circuitry of FIG. 3.

FIG. 11 is a flowchart representative of example machine-readable instructions and/or example operations that may be executed, instantiated, and/or performed by example programmable circuitry to implement the shape condenser circuitry of FIG. 3.

FIG. 12 is a flowchart representative of example machine-readable instructions and/or example operations that may be executed, instantiated, and/or performed by example programmable circuitry to implement the model manager circuitry of FIG. 3.

FIG. 13 is an illustrative example of traffic scheduling that may be performed by the server of FIG. 2A to implement the communications of FIG. 12.

FIG. 14 is a block diagram of an example processing platform including programmable circuitry structured to execute, instantiate, and/or perform the example machine-readable instructions and/or perform the example operations of FIGS. 9-12 to implement a camera and/or the server of FIG. 3.

FIG. 15 is a block diagram of an example implementation of the programmable circuitry of FIG. 14.

FIG. 16 is a block diagram of another example implementation of the programmable circuitry of FIG. 14.

FIG. 17 is a block diagram of an example software/firmware/instructions distribution platform (e.g., one or more servers) to distribute software, instructions, and/or firmware (e.g., corresponding to the example machine-readable instructions of FIGS. 9-12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 18 illustrates an overview of an Edge cloud configuration for Edge computing.

FIG. 19 illustrates operational layers among endpoints, an Edge cloud, and cloud computing environments.

FIG. 20 illustrates an example approach for networking and services in an Edge computing system.

In general, the same reference numbers will be used throughout the drawing(s) and accompanying written description to refer to the same or like parts. The figures are not necessarily to scale.

### DETAILED DESCRIPTION

Generating 3D models of changing environments is a challenging technical task. Furthermore, industry members seek cost effective approaches for generating 3D models so that price is not a prohibitive factor when incorporating the technology into a product. Some industry members may additionally or alternatively seek time efficient approaches for generating 3D models so that products can make real-time (or at near-real-time) decisions using the models.

Example methods, apparatus, and systems described herein enable cost effective and time efficient generation of 3D models that capture dynamic environments from long ranges. Example cameras include segment creator circuitry to passively capture and segment images based on motion over a time window in a probabilistic manner, coping with changing lighting conditions, noise and occlusions that are common in long-range sensing. As used above and herein, passive capture refers to computer vision operations other than active sensing (e.g., the transmission of an electromagnetic signal). The example cameras may, however, perform operations that are considered active perception (e.g., processing sensory data to enable computer vision applications).

The example segment creator circuitry smoothly and continuously obtains pixel-wise normalized confidence values splitting foreground-dynamic from stationary-background objects through a stochastic parameter-free approach. For example, the segment creator circuitry may indicate how likely a pixel is to be either a dynamic object or a static one in a scene with respect to each pixel independently and without parametric distribution over time. Accordingly, pixel-wise normalized confidence values are free from probability distribution per pixel, thereby allowing general representation of scenes with temporal adaptation to changes in illumination and/or weather conditions.

Example cameras also include shape condenser circuitry to create and split density quads based on destiny dispersion in a recursive manner, thereby enabling efficient control over the level-of-detail when dynamically adjusting resolution according to sensing-range and network conditions for optimal effort-to-resolution tradeoffs. The example shape condenser circuitry implements density-quad decomposition and low-level marshalling to condense the density quads into a data transmission protocol (e.g., a Transmission Control Protocol (TCP)-Internet Protocol (IP) frame) for transmission over a network. The frame is received by an example server implementing model manager circuitry, which computes the collective hierarchical intersection of density quads via parallelized vertex enumeration producing polycells. As discussed further below, a polycell refers to a region of 3D space encapsulated by oriented planes. The example model manager circuitry also enhances the individual density acutance of polycells (e.g., the likelihood of a combination of views from diverse vantage points defining a 3D space that contains an object) and removes low confidence polycells.

The output of the example model manger circuitry is a 3D model of an object within a scene captured by the example camera. As used above and herein, density refers to the probability of a given condition being satisfied. For example, foreground density refers to the probability that an object (e.g., a pixel, quad, polycell, etc.) is in the foreground of an image. In some examples, density and confidence values may be additionally or alternatively referred to as non-normalized probabilities.

In some examples, 3D models generated by the teachings of this disclosure may be produced in less time, at less cost, and with more potential use cases than other approaches to generate 3D models. Furthermore, examples described herein can be implemented on already installed cameras, thereby providing new capabilities with existing infrastructure. In addition, the teachings of this disclosure support a large number of cameras per server when compared to 3D dense reconstruction with texture matching techniques. Accordingly, the teachings of this disclosure provide scalability for applications to monitor, segment and model dynamic entities across an environment with minimal server overhead.

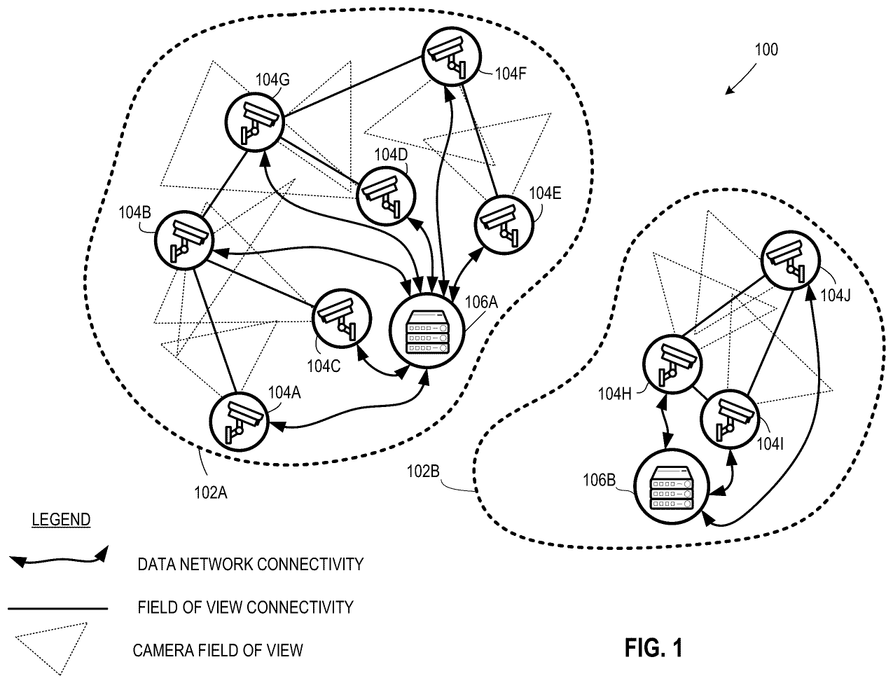

FIG. 1 is a block diagram of an example system to model volumetric representations. The example system 100 of FIG. 1 includes example cliques 102A and 102B. The clique 102A includes example cameras 104A-104G and an example server 106A. The clique 102B includes example cameras 104H-104J and an example server 106B. The example cameras 104A-104G may be collectively referred to as cameras 104, and the example servers 106A and 106B may be collectively referred to as servers 106.

As used herein, a clique refers to a set of devices that work together to generate 3D models in accordance with the teachings of this disclosure. That is, the cliques 102A and 102B create two separate models. In general, a clique includes one or more cameras 104 and one or more servers 106. In the example of FIG. 1, the system 100 includes one server 106 per clique 102. In some examples, one server may support multiple cliques, or a single clique may be supported by multiple servers. In some examples, a clique may be referred to as a group or a cluster.

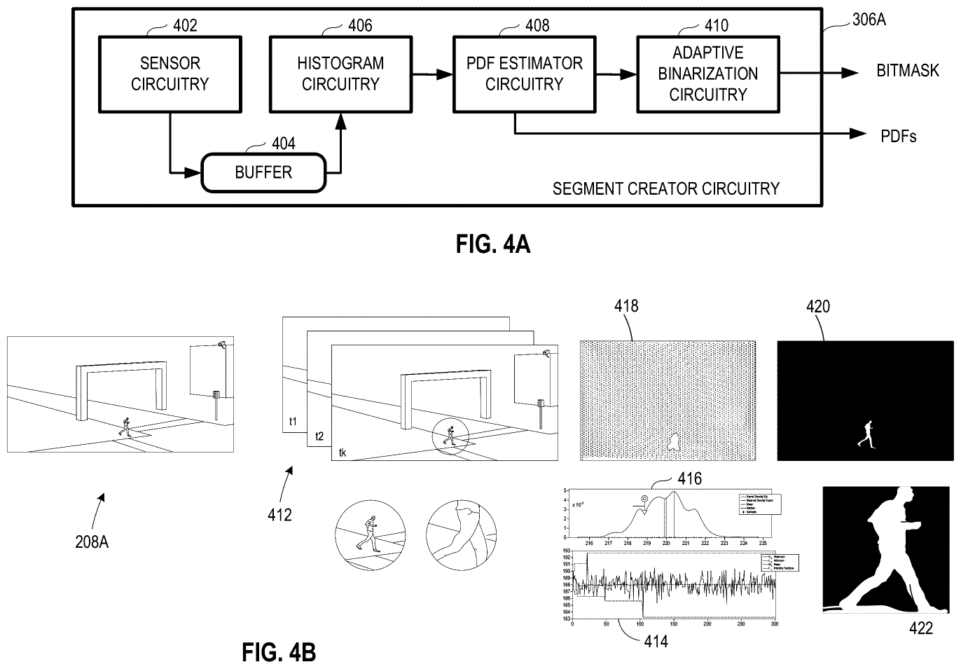

The cameras 104 within the example of FIG. 1 observe objects in a scene and describe the observed objects in accordance with the teachings of this disclosure. To do so, the cameras 104 takes images of an environment, divides the images into segments based on their probability of being in the foreground of the image, and produce density quads of the segments. As used above and herein, a density quad refers to sub-regions of an object formed such that the sub-regions have a particular shape (e.g., squares) and define portions of the object at varying resolutions. Density quads are discussed further in connection with FIGS. 4A and 4B.

A given camera 104A in the example of FIG. 1 includes a System on a Chip (SoC) to implement the foregoing operations in accordance with the teachings of this disclosure. The SoC may be implemented by any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

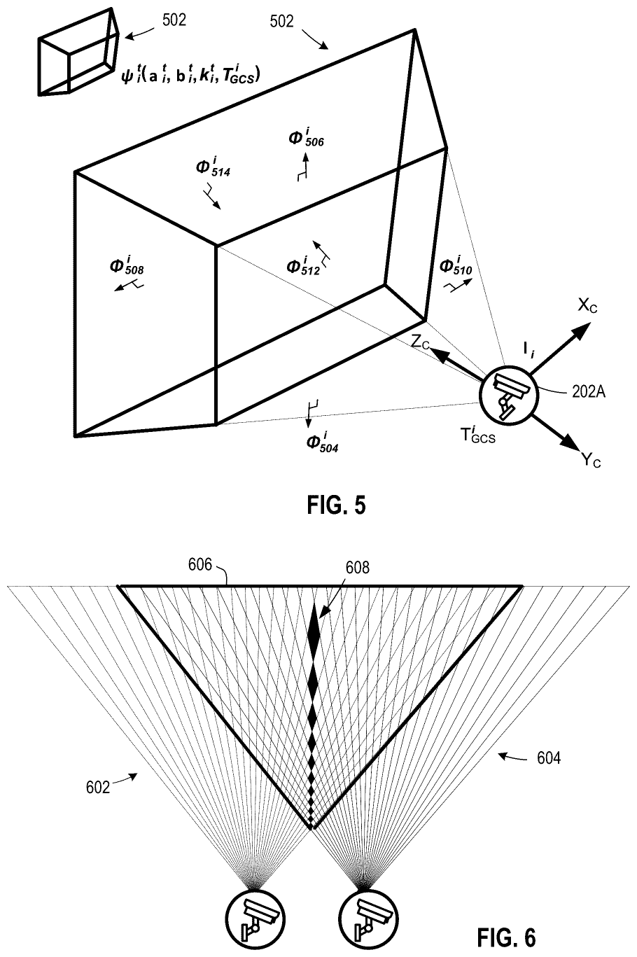

A given camera 104A includes a kinematic and optical state that is defined and sharable over a network. In some examples, one or more of the cameras 104 are Pan, Tilt and Zoom (PTZ) cameras that include mechanical actuators to change the field of views. In some examples, one or more of the cameras 104 lack such actuators and maintain a static configuration. The kinematic positioning of the cameras 104 is discussed further in connection with FIG. 5.

In some examples, one or more of the cameras 104 have mechanical composed lenses, featuring zoom and focus capabilities that affect the principal point and focal distances and depth of field. In some examples, the example cameras 104 correct lens distortion artifacts such that subsequent local and remote computation for 3D modeling is invariant to these distortion.

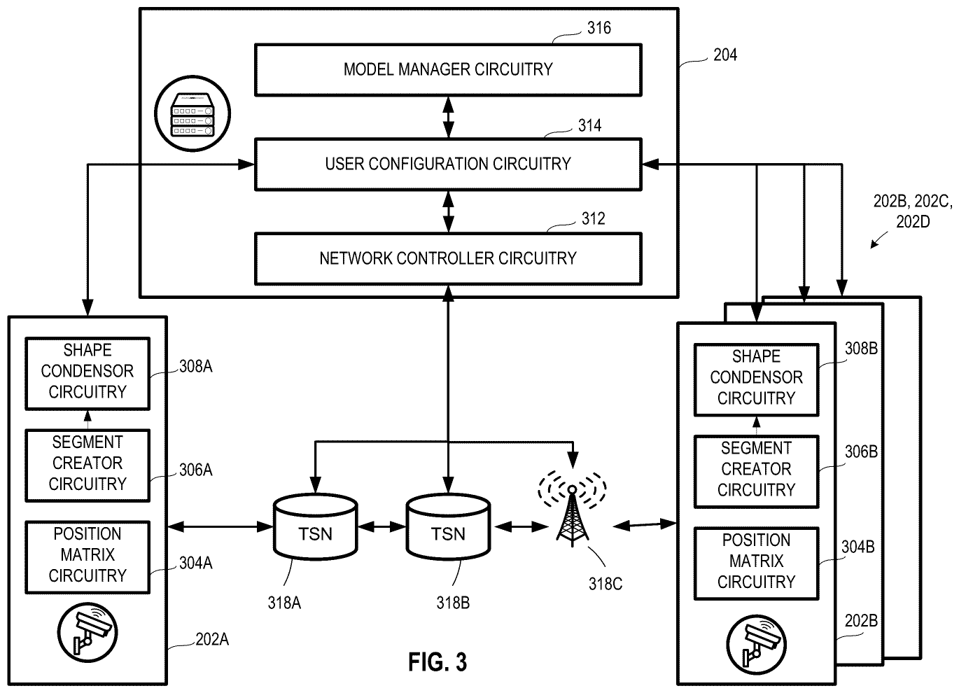

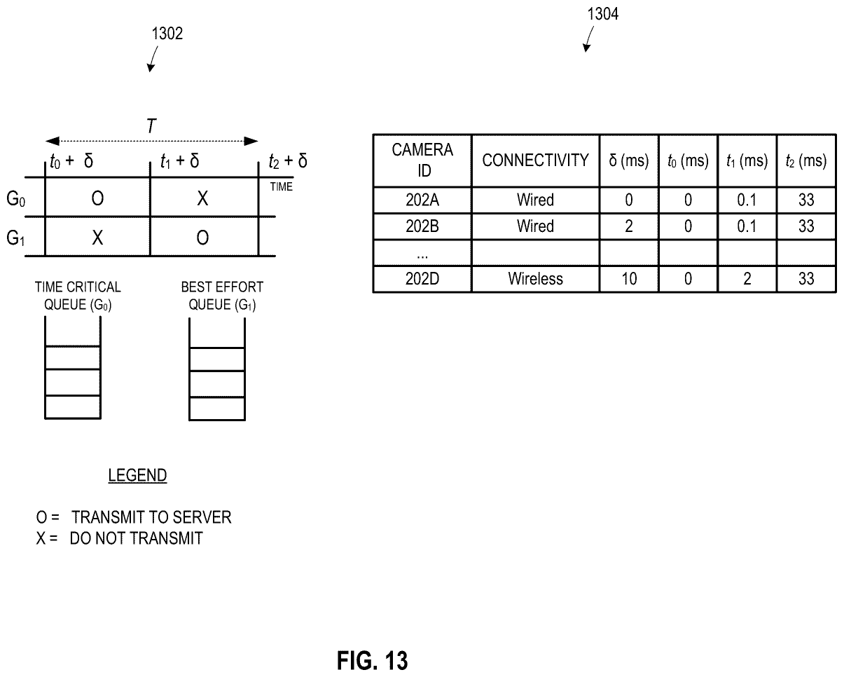

Within the clique 102A, the cameras 104A-104G communicate with the server 106A via a network. Similarly, within the clique 102B, the cameras 104H-104J communicate with the server 106A via a network. In examples described herein, the network is the Internet. However, the example network may be implemented using any suitable wired and/or wireless network(s) including, for example, one or more data buses, one or more local area networks (LANs), one or more wireless LANs (WLANs), one or more cellular networks, one or more coaxial cable networks, one or more satellite networks, one or more private networks, one or more public networks, etc. As used above and herein, the term “communicate” including variances (e.g., secure or non-secure communications, compressed or non-compressed communications, etc.) thereof, encompasses direct communication and/or indirect communication through one or more intermediary components and does not require direct physical (e.g., wired) communication and/or constant communication, but rather includes selective communication at periodic or aperiodic intervals, as well as one-time events. In some examples, one or more of the cameras 104 may communicate directly with the server 106 within the respective clique 102 via a network. Network communications between a camera 104A and a server 106A are discussed further in connection with FIGS. 3 and 13.

The servers 106 in the example of FIG. 1 receive both position data and image data over a network from the cameras 104 within the respective cliques 102A, 102B. The servers 106 aggregate and process the position and image data of multiple cameras to produce a 3D model in accordance with the teachings of this disclosure. To do so, the servers 106 generate the models by calculating three dimensional regions from cameras that share a common field of view. A common field of view refers to when two or more cameras 104 observe some or all of the same scene (e.g., the environment, dynamic objects, etc.). In the example of FIG. 1, the camera 104B shares a common field of view with camera 104A and 104C, the cameras 104H-104J all share a common field of view with one another, etc.

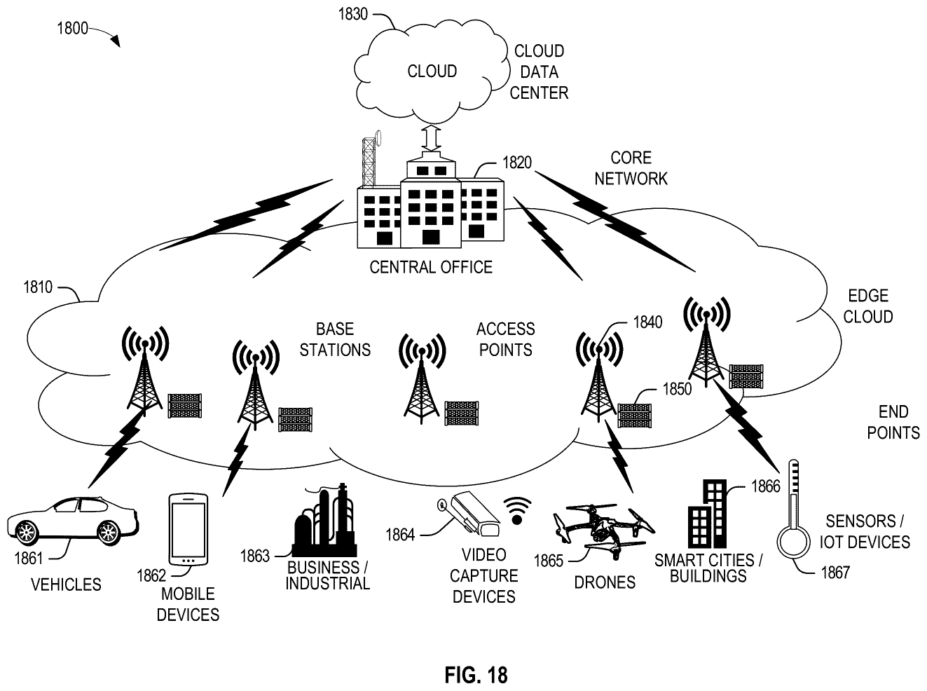

The servers 106 in the example of FIG. 1 may be implemented as edge servers within an edge cloud. The example servers 106 are discussed further in connection with FIG. 3. An example edge cloud is discussed further in connection with FIGS. 18-20.

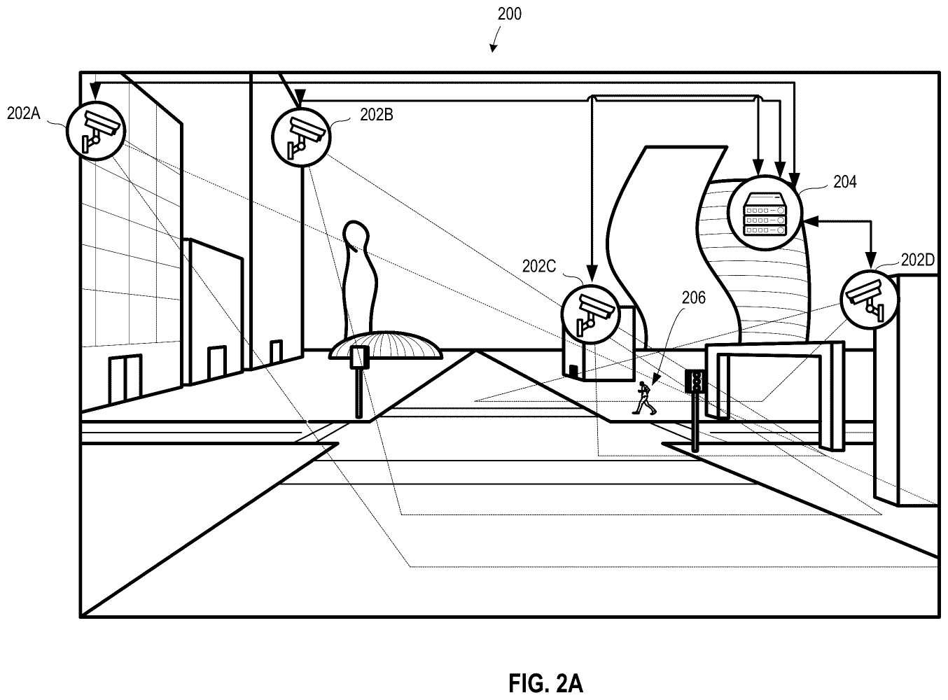

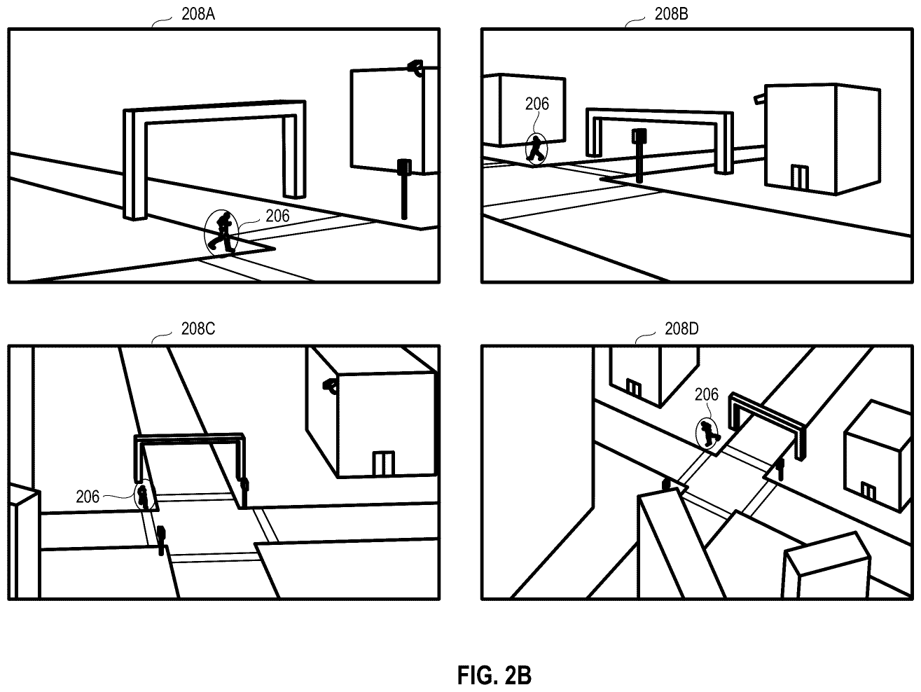

FIG. 2A is an illustrative example of an environment that implements a clique as described in connection with FIG. 1. FIG. 2A shows an example environment 200 that includes example cameras 202A-202D (collectively referred to as cameras 202), an example server 204, and an example object 206. FIG. 2B are the perspective views of the cameras 202 of FIG. 2A. FIG. 2B includes example fields of view 208A-208D. The example cameras 202 and server 204 collectively form a clique.

The environment 200 of the example of FIG. 2A is an urban area that includes an intersection. In some examples, the environment 200 may be any space where 3D models may be used. Examples of said environments include but are not limited to a classroom, a conference room, a parking lot, a highway, an airport, a store, a factory, etc.

The environment 200 includes the object 206. In the example of FIG. 2A, the object 206 is a pedestrian. In some examples, the object 206 may be an animal, a vehicle, a shopping cart, luggage, etc. As used above and herein, objects within an environment may be referred to as dynamic because their position and/or orientation may change over time. For example, FIG. 2A shows the pedestrian (e.g., the object 206) about to cross the intersection.

The cameras 202 within the example of FIG. 2A are example implementations of the cameras 104 of FIG. 1. The cameras 202 may be considered long range cameras in that the cameras' regions of focus (e.g., the intersection) may be on the scale of tens or hundreds of meters away from the cameras 202. In contrast, short range cameras (e.g., cameras that may be used to record users for video conferencing programs) may have a region of focus that is feet or inches from the camera.

The cameras 202 may be positioned anywhere within the environment 200 (e.g., on a lamp post, an overpass sign, the side of a building, etc.). In the example of FIG. 2A, the cameras 202 are PTZ cameras that may have different kinematic poses. Accordingly, the cameras 202 observe the environment 200 from different perspectives. For example, the camera 202A of FIG. 2A observes the field of view 208A of FIG. 2B, the camera 202B of FIG. 2A observes the field of view 208B of FIG. 2B, the camera 202C of FIG. 2A observes the field of view 208C of FIG. 2B, and the camera 202D of FIG. 2A observes the field of view 208D of FIG. 2B. The cameras 202 are discussed further in connection with FIGS. 3-7C.

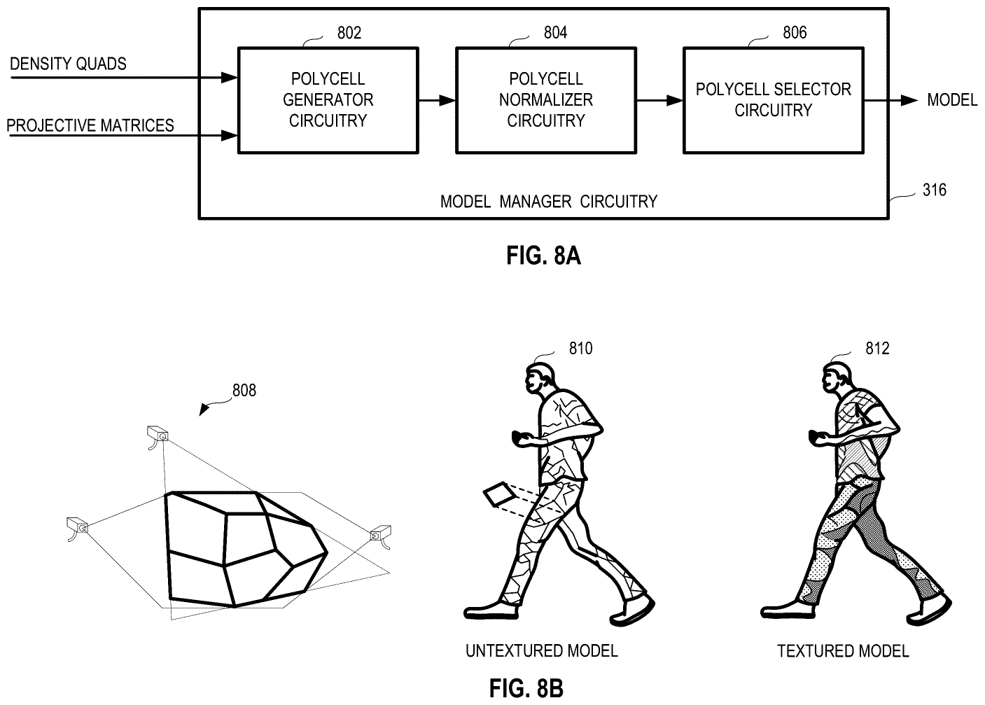

In the example of FIG. 2B, the fields of view 208A-208D all include the object 206. Accordingly, the server 204 can combine image and position data from any combination of the cameras 202 to produce a 3D model in accordance with the teachings of this disclosure. The server 204 of FIG. 2A is an example implementation of one of the servers 106 of FIG. 1. The server 204 is discussed further in connection with FIGS. 3, 8A and 8B.

FIG. 3 is a block diagram of an example implementation of the clique of FIG. 2A (e.g., the cameras 202 and the server 204). One or more of the cameras 202 and the server 204 of FIG. 2A may be instantiated (e.g., creating an instance of, bring into being for any length of time, materialize, implement, etc.) by programmable circuitry such as a Central Processor Unit (CPU) executing first instructions. Additionally or alternatively, the clique of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In FIG. 3, the camera 202A includes example position matrix circuitry 304A, example segment creator circuitry 306A, and example shape condenser circuitry 308A. Similarly, the camera 202B includes example position matrix circuitry 304B, example segment creator circuitry 306B, and example shape condenser circuitry 308B, etc. The server 204 in FIG. 3 includes example network controller circuitry 312, example user configuration circuitry 314, and example model manager circuitry 316. FIG. 3 also includes example Time Sensitive Networking (TSN) bridges 318A, 318B and 318C (collectively referred to as TSN bridges 318).

While examples described herein may discuss circuits and operations with respect to the camera 202A, the same or similar circuits and operations may be implemented within each of the cameras 202 in accordance with the teachings of this disclosure.

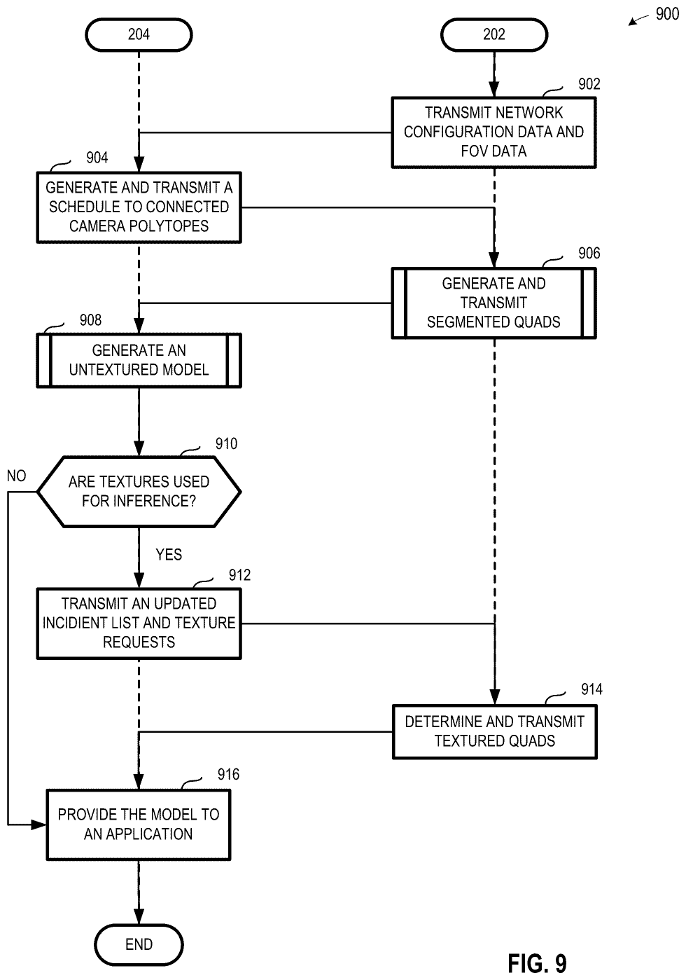

The position matrix circuitry 304A in the example of FIG. 3 describes a region of space that is visible to the camera 202A. The position matrix circuitry 304A also describes how that region of visibility changes over time. The position matrix circuitry 304A calculates the region of visibility based on device-specific parameters (e.g., the location, the pan, the tilt, the lens distortion, etc. of the camera 202A). The position matrix circuitry 304A provides a description of the visibility region to the server 204 via a network. In some examples, the position matrix circuitry 304A is instantiated by programmable circuitry executing position matrix instructions and/or configured to perform operations such as those represented by the flowchart(s) of FIG. 9-12. The position matrix circuitry 304A is discussed further in connection with FIG. 5.

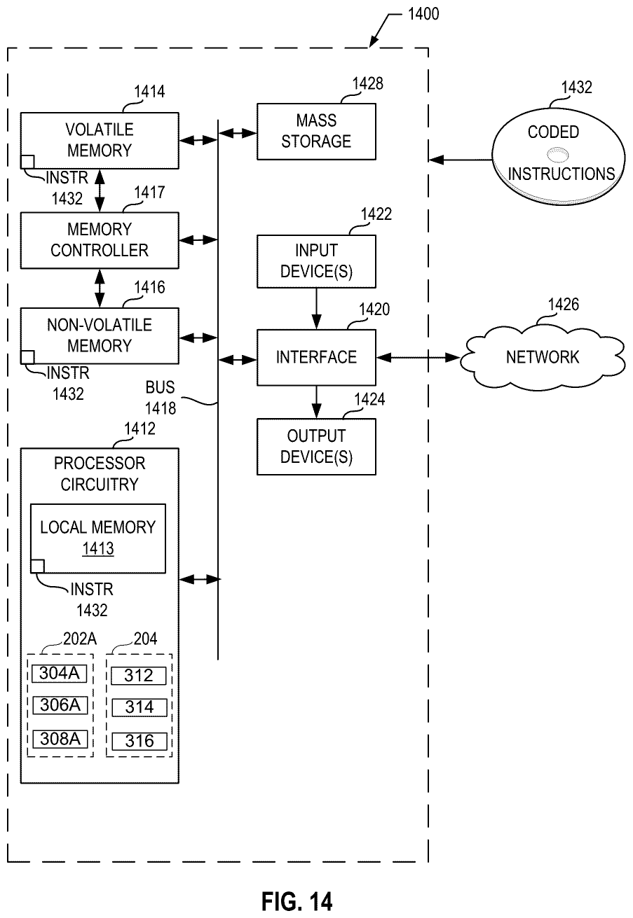

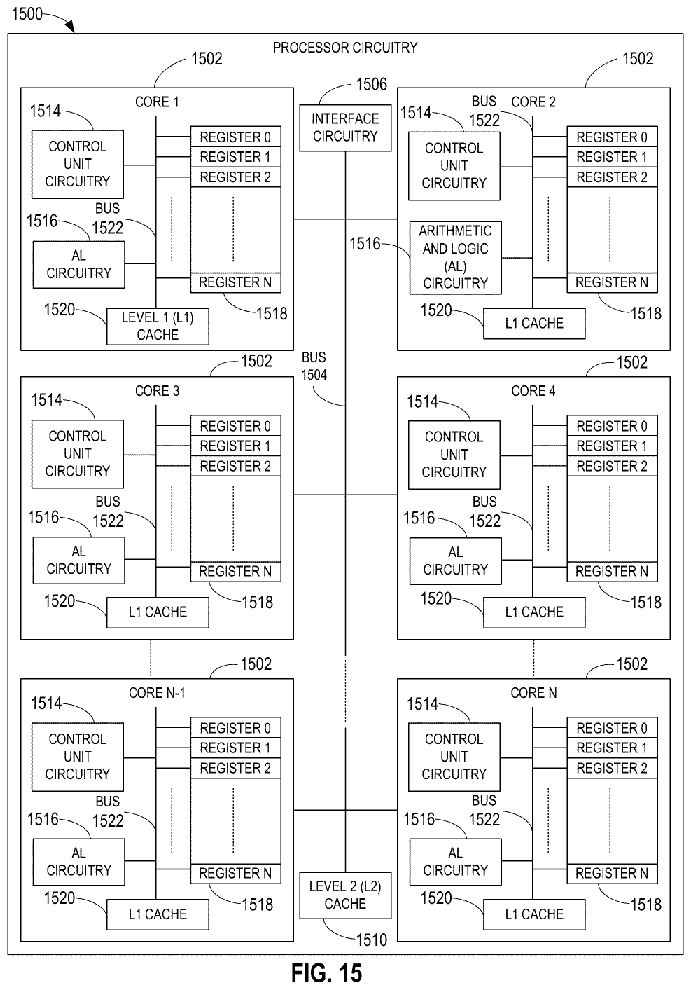

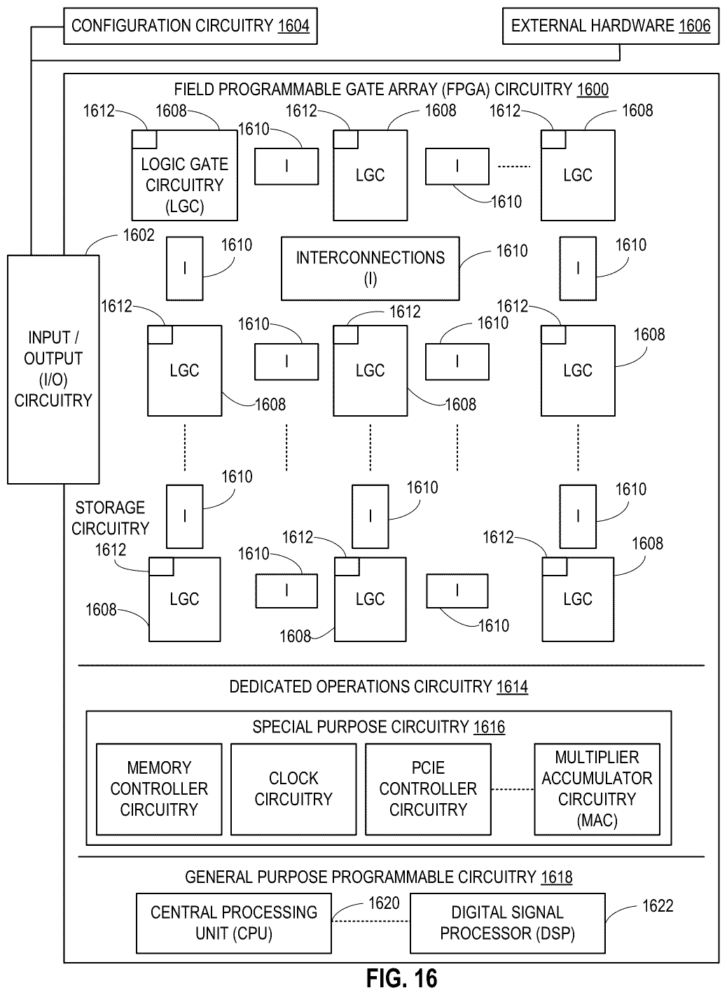

In some examples, the clique includes means for providing field of view data. For example, the means for providing field of view data may be implemented by position matrix circuitry 304A. In some examples, the position matrix circuitry 304A may be instantiated by programmable circuitry such as the example programmable circuitry 1412 of FIG. 14. For instance, the position matrix circuitry 304A may be instantiated by the example microprocessor 1500 of FIG. 15 executing machine executable instructions such as those implemented by at least blocks 902 of FIG. 9. In some examples, the position matrix circuitry 304A may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the position matrix circuitry 304A may be instantiated by any other combination of hardware, software, and/or firmware. For example, the position matrix circuitry 304A may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

Within the camera 202A, the segment creator circuitry 306A takes images of the environment 200 and models the individuals pixels within the images as an independent stochastic process. The segment creator circuitry 306A then uses the individual pixel models to form a bitmask for a given image. As used herein, a bitmask refers to binary values assigned to respective pixels in an image that describe whether a given one of the pixels is in the foreground or background. (e.g., a value of ‘True’ may indicate a given pixel is part of the foreground, while a value of ‘False’ may indicate the pixel is part of the background). In some examples, the segment creator circuitry 306A is instantiated by programmable circuitry executing segment creator instructions and/or configured to perform operations such as those represented by the flowchart(s) of FIG. 9-12. The segment creator circuitry 306A is discussed further in connection with FIGS. 4A and 4B.

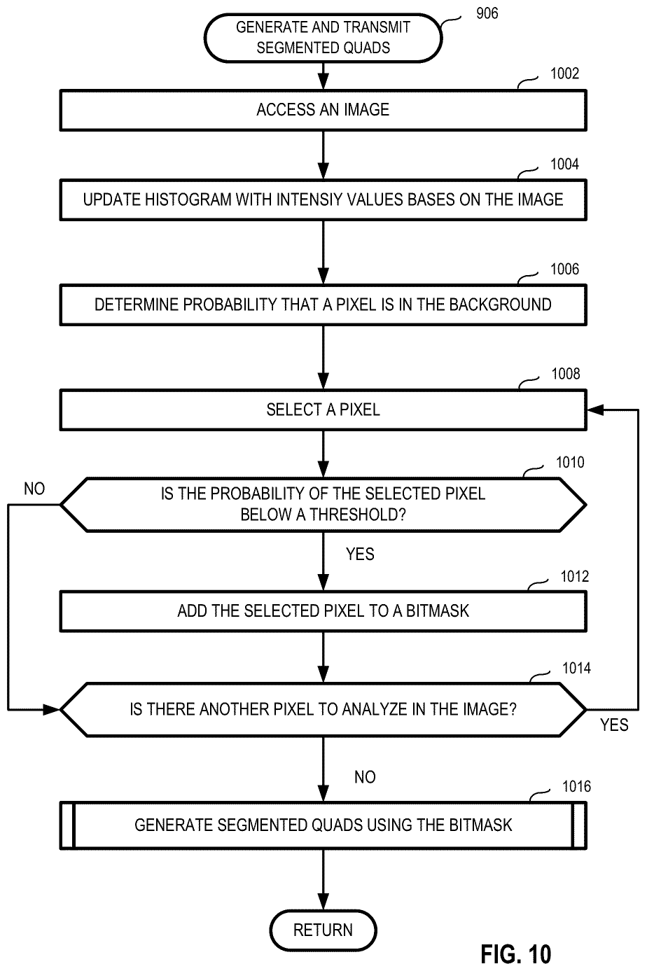

In some examples, the clique includes means for creating segments. For example, the means for creating segments may be implemented by segment creator circuitry 306A. In some examples, the segment creator circuitry 306A may be instantiated by programmable circuitry such as the example programmable circuitry 1412 of FIG. 14. For instance, the segment creator circuitry 306A may be instantiated by the example microprocessor 1500 of FIG. 15 executing machine executable instructions such as those implemented by at least blocks 906, 1002-1014 of FIGS. 9 and 10. In some examples, the segment creator circuitry 306A may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the segment creator circuitry 306A may be instantiated by any other combination of hardware, software, and/or firmware. For example, the segment creator circuitry 306A may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

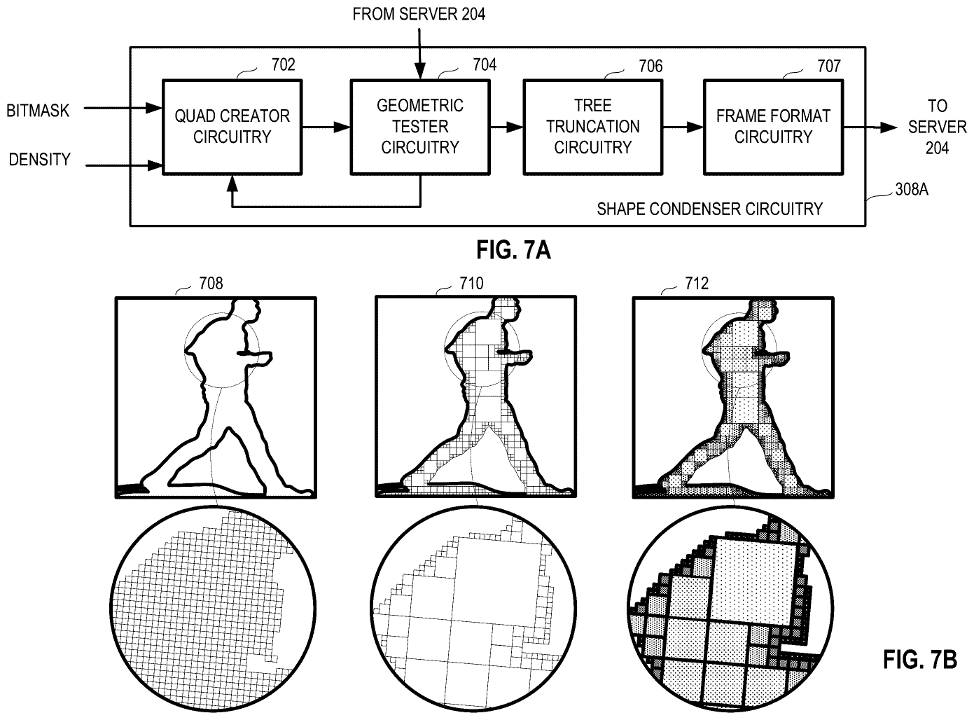

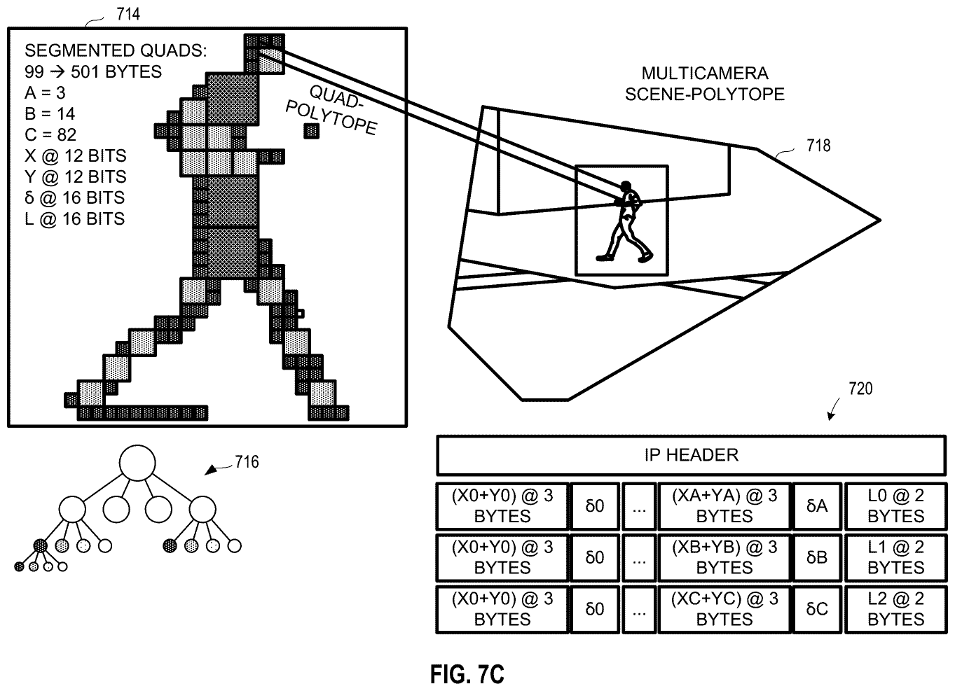

Within the camera 202A, the shape condenser circuitry 308A uses both the bitmask and the individual pixel models to group adjacent pixels into quads. The shape condenser circuitry 308A forms the quads such that: a) the quads are a particular shape (e.g., a square) and b) the pixels in a quad share the same or similar probability (e.g., within a tolerance) of being in the foreground. The shape of the quads and/or the tolerance can be pre-determined, specified as a configuration input, etc. In examples described herein, the shape condenser circuitry 308A provides a subset of quads (e.g., those quads having a probability over a threshold value) to the server 204 by transmitting a TCP/IP frame over the network. In some examples, the shape condenser circuitry 308A may provide the quads using a different data transmission protocol. In some examples, the shape condenser circuitry 308A is instantiated by programmable circuitry executing shape condenser instructions and/or configured to perform operations such as those represented by the flowchart(s) of FIG. 9-12. The shape condenser circuitry 308A is discussed further in connection with FIGS. 7A, 7B, and 7C.

In some examples, the clique includes means for condensing shapes. For example, the means for condensing shapes may be implemented by shape condenser circuitry 308A. In some examples, the shape condenser circuitry 308A may be instantiated by programmable circuitry such as the example programmable circuitry 1412 of FIG. 14. For instance, the shape condenser circuitry 308A may be instantiated by the example microprocessor 1500 of FIG. 15 executing machine executable instructions such as those implemented by at least blocks 906, 1016, and 1102-114 in FIGS. 9-11. In some examples, the shape condenser circuitry 308A may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the shape condenser circuitry 308A may be instantiated by any other combination of hardware, software, and/or firmware. For example, the shape condenser circuitry 308A may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

Within the server 204, the user configuration circuitry 314 receives network configuration data from the cameras 202. The network configuration data may include but is not limited to packet size, packet periodicity, etc. The user configuration circuitry 314 also receives TCP/IP frames containing image quad data from the cameras 202 and position data from the cameras 202. In some examples, the user configuration circuitry 314 is referred to as a Centralized User Configuration (CUC). In some examples, the user configuration circuitry 314 is instantiated by programmable circuitry executing user configuration instructions and/or configured to perform operations such as those represented by the flowchart(s) of FIG. 9-12.

In some examples, the clique includes means for receiving camera data. For example, the means for receiving camera data may be implemented by user configuration circuitry 314. In some examples, the user configuration circuitry 314 may be instantiated by programmable circuitry such as the example programmable circuitry 1412 of FIG. 14. For instance, the user configuration circuitry 314 may be instantiated by the example microprocessor 1500 of FIG. 15 executing machine executable instructions such as those implemented by at least blocks 904, 908 of FIG. 9. In some examples, the user configuration circuitry 314 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the user configuration circuitry 314 may be instantiated by any other combination of hardware, software, and/or firmware. For example, the user configuration circuitry 314 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

Within the server 204, the network controller circuitry 312 obtains network configuration parameters from the cameras 202 via the network and the user configuration circuitry 314. The network controller circuitry 312 uses the network configuration parameters to design a schedule for the respective cameras 202. By scheduling a given camera 202A, the network controller circuitry 312 enables the camera 202A to trigger itself (e.g., to take one or more pictures and send a TCP/IP frame to the server) based on the position of the camera 202A within the schedule. To ensure proper alignment between camera transmission window and camera data generation, the camera 202A triggers itself based on data provided in the schedule. In some examples, the camera 202A self-triggers with a predefined and constant time offset. In other examples, the camera 202A does not use a time offset to self-trigger or uses an offset that changes over time based on the schedule.

As used herein, a schedule refers to timing data that instructs one or more cameras 202 to take an image and generate segmented quads of the foreground. For example, the network controller circuitry 312 may generate a schedule that specifies time frames where a given camera in the clique (e.g., camera 202A) can communicate with the server 204. During such a time frame, the schedule may prevent other cameras in the clique (e.g., cameras 202B, 202C, 202D) from communicating with the server. In doing so, the schedule prevents network interference in the form of crosstalk between devices in the clique, thereby increasing the reliability of the clique.

In some examples, the network controller circuitry 312 is referred to as a Central Network Controller (CNC). In some examples, the network controller circuitry 312 is instantiated by programmable circuitry executing network controller instructions and/or configured to perform operations such as those represented by the flowchart(s) of FIG. 9-12.

In some examples, the clique includes means for determining a schedule. For example, the means for determining a schedule may be implemented by network controller circuitry 312. In some examples, the network controller circuitry 312 may be instantiated by programmable circuitry such as the example programmable circuitry 1412 of FIG. 14. For instance, the network controller circuitry 312 may be instantiated by the example microprocessor 1500 of FIG. 15 executing machine executable instructions such as those implemented by at least blocks 904 of FIG. 9. In some examples, the network controller circuitry 312 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the network controller circuitry 312 may be instantiated by any other combination of hardware, software, and/or firmware. For example, the network controller circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

Within the server 204, the model manager circuitry 316 obtains position and image data from the cameras 202 via the network and the user configuration circuitry 314. The model manager circuitry 316 computes a polycell based on the intersection of two camera perspectives corresponding to the quad. The model manager circuitry 316 then normalizes and reduces the polycells, thereby producing a polyhedral approximation 3D model of the object 206. In some examples, the model manager circuitry 316 is instantiated by programmable circuitry executing model manager instructions and/or configured to perform operations such as those represented by the flowchart(s) of FIG. 9-12. Polycells and the model manager circuitry 316 are discussed further in connection with FIGS. 8A and 8B.

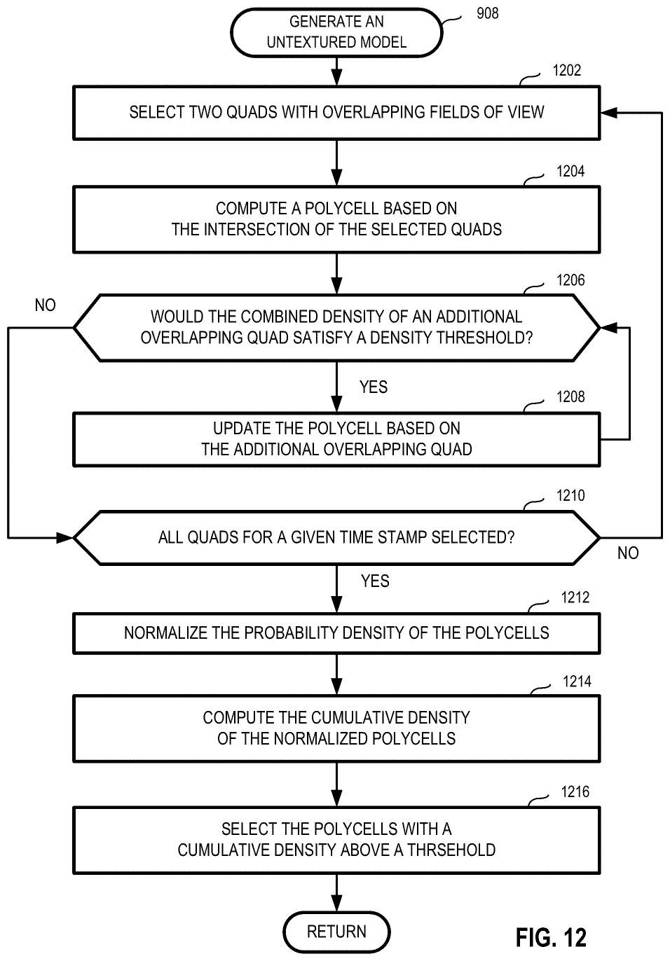

In some examples, the clique includes means for generating polycells. For example, the means for generating polycells may be implemented by model manager circuitry 316. In some examples, the model manager circuitry 316 may be instantiated by programmable circuitry such as the example programmable circuitry 1412 of FIG. 14. For instance, the model manager circuitry 316 may be instantiated by the example microprocessor 1500 of FIG. 15 executing machine executable instructions such as those implemented by at least blocks 908, 1202-1216 of FIGS. 9 and 12. In some examples, the model manager circuitry 316 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the model manager circuitry 316 may be instantiated by any other combination of hardware, software, and/or firmware. For example, the model manager circuitry 316 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The example TSN bridges 318 are edge devices that provide a global clock signal used to synchronize the cameras 202. The TSN bridges 318 establish the global clock signal using TSN, a communication standard by the Institute of Electrical and Electronics Engineers (IEEE). Examples of TSN protocols implemented by the TSN bridges 318 include but are not limited to the IEEE 802.1AS-2011 and 802.1AS-2020 protocols (published in 2011 and 2020, respectively). The TSN bridges 318 may achieve time synchronization accuracies with the cameras 202 on the order of nanoseconds for wired devices (e.g., the TSN bridges 318A and 318B) and single digit microseconds in the case of wireless devices (e.g., the TSN bridges 318C). In the example environment 200 of FIG. 2, the TSN bridges 318 are implemented within infrastructure that connects the cameras 202 to the server 204 (e.g. a Wi-Fi access point, a cellular base station, etc.).

In some examples, the network controller circuitry 312 can both: a) reduce noise by implementing time frames where only one device transmits data, and b) support applications that make inferences in real time or substantially real-time using 3D models. To support such time sensitive applications, the clique implements the low latency communication described above and limits the length of messages that cross the network. For example, a message may be limited in length to one TCP/IP frame transmitted per camera and per image. The length of a message sent by the cameras 202 is discussed further in connection with FIGS. 7A, 7B, and 7C.

The low latency time synchronization also enables the network controller circuitry 312 within the server 106 to coordinate triggering of the cameras 202 in a basic service set (BSS). In some examples, the TSN bridges 318 are instantiated by programmable circuitry executing TSN bridge instructions and/or configured to perform operations such as those represented by the flowchart(s) of FIG. 9-12.

FIG. 3 shows an example implementation of how devices within the environment 200 generate a model of the object 206 in accordance with the teachings of this disclosure. In the illustrated example, the shape condenser circuitry 308A within the example camera 202A groups pixels into quads and removes quads with low probabilities of being in the foreground, thereby compressing the data sent to the server 106 for a given image into a TCP/IP frame. The coordination of the user configuration circuitry 314, network controller circuitry 312, and TSN bridges 318 enables the model manager circuitry 316 to obtain the image data in a time critical manner (e.g., using real-time or substantially real-time communications). Furthermore, the example model manager circuitry 316 combines the image data and position data of multiple cameras to compute polycells in a time efficient manner (e.g., at a sub-millisecond per polycell rate). As a result, the server 204 can generate a 3D model of the object 206 quickly enough for other applications in the edge to make inferences using the 3D model. For example, a 3D model of the pedestrian (e.g., the object 206) crossing the intersection of FIGS. 2A, 2B may be used by applications that cause an overpass sign to change, send an alert to be sent to nearby vehicles, update usage statistics corresponding to the intersection, etc.

FIG. 4A is a block diagram of an example implementation of the segment creator circuitry 306A of FIG. 3. FIG. 4B is an illustrative example of operations performed by the segment creator circuitry as described in FIG. 4A. In FIG. 4A, the segment creator circuitry 306A includes example sensor circuitry 402, an example buffer 404, example histogram circuitry 406, example Probability Density Function (PDF) estimator circuitry 408, and example adaptive binarization circuitry 410. FIG. 4B includes the view 208A, example images 412, example graph 414, example histogram 416, example visualizations 418 and 420, and example bitmask 422.

The example sensor circuitry 402 captures the images 412, which show how the environment 200 changes over time from the perspective of the view 208A. The sensor circuitry 402 may be implemented by any type of optical sensor (e.g., resonance, dispersion, reflection, refraction, phosphorescence, etc.). In the example of FIG. 4, the camera 202A captures the environment 200 in color and desaturates the resultant data to produce the images 412 in greyscale.

The example sensor circuitry 402 stores the images 412 in the buffer 404. The buffer 404 refers to an amount of memory accessible to the camera 202A. The buffer 404 may be implemented as any type of memory. For example, the buffer 404 may be a volatile memory, a non-volatile memory, or a combination thereof. The volatile memory may be implemented by Synchronous Dynamic Random Access Memory (SDRAM), Dynamic Random Access Memory (DRAM), and/or any other type of RAM device. The non-volatile memory may be implemented by flash memory and/or any other desired type of memory device.

The buffer 404 may operate as a First In First Out (FIFO) buffer having a fixed capacity of s samples. The sensor circuitry 402 adds data to the buffer 404 by storing the images 412 as they are captured and desaturated. Similarly, the histogram circuitry 406 then removes the images 412 in chronological order.

The histogram circuitry 406 maintains one histogram per pixel position within an image. That is, if the sensor circuitry 402 produces 1920*1080=2,073,600 pixels per image, then the histogram circuitry 406 may updates 2,073,600 instances of the histogram 416 per image captured.

In the example of FIG. 4A, the histogram circuitry 406 updates the histogram 416 by adding a data point to represent the intensity of the pixel in the newest image. The histogram circuitry 306 also updates the histogram 416 by removing the data point that represents the intensity of the pixel in the oldest image. In some examples, the histogram circuitry 306 additionally or alternatively updates the histogram 416 by plotting the hue of the pixel across time. In some examples, the histogram circuitry 306 also performs updates by adding data points from the newest image and removing data points from the oldest image. In some examples, the intensity and/or hue of a given pixel coordinate may be tracked over time as shown in the graph 414.

Described mathematically, within a histogram Ĥ at pixel coordinates (u, v) and sample s, there exists an intensity object with maximal frequency f at intensity z, such that Ĥ(u, v, s) [symbol] (f, z) ∈ N.

The PDF estimator circuitry 408 uses the histogram 416 to determine a Gaussian kernel density function as defined in Equation (1):

G_{b}(I(u,v),Ĥ(u,v,s))=e^{-σ(l(u,v)-z)}^{²} (1)

Equation (1) states that the Gaussian kernel density function of the background, G_{b}, is a function of: a) the intensity value I at pixel coordinates (u, v), and b) the histogram Ĥ at pixel coordinates (u, v) and sample s. Equation (1) also states that the Gaussian kernel density function is based on σ, an empirically estimated value that represents the segmentation acutance (e.g., the segmentation sharpness) of the camera 202A, and z, the intensity at maximal frequency f.

After the histogram 416 is updated, the PDF estimator circuitry 408 uses G_{b} as defined in Equation (1) to determine the likelihood of the newest data point being part of the background. To do so, the PDF estimator circuitry 408 computes an integral of data points surrounding the newest data point. If the output of the integral is above a threshold defined by G_{b}, then the pixel has a high probability of being in the background of the image. For example, the computation of the integral and comparison to G_{b} by the PDF estimator circuitry 408 creates a probability distribution (e.g., a PDF) describing the likelihood of a particular pixel being in the background. The range of probabilities each pixel possesses is represented in the visualization 418, and the PDF estimator circuitry 408 stores the corresponding data in a memory accessible to the camera 202A.

The example adaptive binarization circuitry 410 assigns a given pixel to either the foreground or the background of an image. To do so, the example adaptive binarization circuitry 410 performs an adaptive binarization technique using the pixel density functions from the PDF estimator circuitry 408. In the example of FIG. 4, the adaptive binarization technique includes integrating the PDFs from a group of adjacent pixels within the image, thereby combining data from multiple different histograms. The result of the adaptive binarization technique is a binary assignment such that a given pixel is now estimated to be in either the foreground or the background of an image. The output of the adaptive binarization circuitry 410 is represented by the visualization 420, which has more contrast than the visualization 418 because a given pixel in 420 has a foreground or background assignment rather than a range of probabilities. The adaptive binarization circuitry 410 may also discard portions of the visualization 420 without foreground pixels, thereby producing the bitmask 422 of the foreground (e.g., the object 206 of FIG. 2A).

FIG. 5 is an illustrative example of a frustum generated associated with a camera. FIG. 5 includes the camera 202A and its associated frustrum 502. In general, a frustrum represents a region of visibility of a corresponding camera. As used herein, the frustrum 502 may additionally or alternatively be referred to as ψᵢ^{t}, where i refers to the index of the camera 202A (e.g., within the set of cameras 202) and t refers to the time at which the frustrum 502 defines the visibility of the camera 202A.

The example camera 202A can change fields of view based by changing its pan and/or tilt. Suppose that at a given time t, the pan of the camera 202A is represented by αₜⁱ and the tilt of the camera 202A is represented by βₜⁱ (where i is an index as discussed above). The example camera 202A can also change fields of view based on its zoom capabilities, which introduce lens distortion to adjust the focal point and/or depth field. The principal point, focal distances, depth of field, and lens distortion are described in a camera matrix kₜⁱ as described in Equation (2):

$${k}_{t}^{i} ∈ {R}^{3 \times 3} \qquad ( 2 )$$

Equation (2) shows that at a given time t, the camera matrix at index i (e.g., the camera 202A) is an object of the R^{3×3} matrix, which represents real coordinate space. In some examples, camera matrix kₜⁱ is referred to as a projection matrix.

In the example of FIG. 5, the PTZ parameters of an ith camera (e.g., camera 202A) at time t are represented as four oriented planes in the Global Coordinate System (GCS). In particular, ϕ₅₀₄ⁱ represents a lower plane, ϕ₅₀₆ⁱ represents an upper plane, ϕ₅₀₈ⁱ represents a left plane, and ϕ₅₁₀ⁱ represents a right plane (with respect to the position and orientation of the camera 202A). In the example of FIG. 5, the GCS implements Mercator coordinates. In some examples, the GCS may implement a different coordinate format.

The planes ϕ₅₀₄ⁱ, ϕ₅₀₆ⁱ, ϕ₅₀₈ⁱ, and ϕ₅₁₀ⁱ are oriented such that the volume between the planes forms a geometric pyramid having an apex at the intersection of [Xᵢ, Yᵢ, Zᵢ] (e.g., the location of the camera 202A having index i). However, the region of visibility of the camera 202A is further limited based on the undistorted image resolution and the depth of field of the camera 202A. In the example of FIG. 5, the image resolution and depth of field are represented by two clippings planes at the minimal and maximal ranges of camera visibility. Namely, ϕ₅₁₂ⁱ represents a near plane and ϕ₅₁₄ⁱ represents a far plane (with respect to the position and orientation of the camera 202A). The volume between the six bounding planes of FIG. 5 (e.g., the region of visibility of the camera 202A) is the frustrum 502. As used herein, a frustrum refers to the portion of a pyramid which remains after its upper part has been cut off by a plane parallel to its base, or which is intercepted between two such planes. Accordingly, the frustrum 502 may be defined using Equation (3):

$${ψ}_{i}^{t} ( {α}_{t}^{i} , {β}_{t}^{i} , {k}_{t}^{i} , {T}_{GCS}^{i} ) := [ {ϕ}_{504}^{i} , {ϕ}_{506}^{i} , {ϕ}_{508}^{i} , {ϕ}_{510}^{i} , {ϕ}_{512}^{i} , {ϕ}_{514}^{i} ] \qquad ( 3 )$$

Equation (3) states that the frustrum 502 (e.g., ψᵢ^{t}), as defined in FIG. 5 as the volume between bounding planes [(ϕ₅₀₄ⁱ, ϕ₅₀₆ⁱ, ϕ₅₀₈ⁱ, ϕ₅₁₀ⁱ, ϕ₅₁₂ⁱ, ϕ₅₁₄ⁱ], is also a function of the pan αₜⁱ, tilt βₜⁱ, camera projection matrix kₜⁱ, and T_{GCS}ⁱ. As used above and herein, T_{GCS}ⁱ a kinematic frame based in part on the location of the camera [Xᵢ, Yᵢ, Zᵢ].

In examples described herein, the example position matrix circuitry 304A may regularly measure the transmit pan, tilt, and projection matrix data from sensors across various points in time. The position matrix circuitry 304A uses the foregoing information in combination with the location of the camera 202A (e.g., a static value that may be known before run time) to determine T_{GCS}ⁱ and to update the frustrum 502 across the various points in time.

FIG. 6 is an illustrative example of polytopes created by intersecting frustums. FIG. 6 includes the cameras 202A and 202B of FIG. 2, example frustrums 602, 604, and 606, and example polytopes 608.

The example frustrums 602 and 604 are implementations of the frustrum 502 as described above in FIG. 5. In the example of FIG. 6, the frustrum 602 represents the region of visibility of the camera 202A and the frustrum 604 represents the region of visibility of the camera 202B. Furthermore, while the frustrums 602 and 604 are three-dimensional shapes, the example of FIG. 6 shows a top (plan) view of the frustrums that result in a two-dimensional projection.

FIG. 6 provides a visual representation of Equation (4):

$${ψ}_{i}^{t} ∧ {ψ}_{j}^{t} ↦ \{ {ψ}_{k ,}^{t} ∅ \} \qquad ( 4 )$$

Equation (4) states that the intersection of two frustrums ψᵢ^{t} and ψⱼ^{t} (e.g., the frustrums 602 and 604) may intersect to form a smaller frustrum ψₖ^{t} (e.g., the frustrum 606) or may not intersect at all (Ø). In the example of FIG. 6, the frustrums 602 and 604 intersect and the smaller frustrum represent the common field of view between cameras 202A and 202B. Alternatively, if two frustrums do not intersect, then the two corresponding cameras do not share a common field of view.

As shown in FIG. 2B, both cameras 202A and 202B have regions of visibility that include the object 206. Accordingly, the object 206 is located within the frustrum 606. In the example of FIG. 6, the portion of the frustrum 606 containing visibility of the object 206 is represented by the polytopes 608.

In addition to the object 206, the camera views 208A and 208B also include other portions of the environment 200. However, because the other portions of the environment 200 are not the subject of the 3D model, the transmission of image data describing such regions could cause latency and/or network congestion. In some examples, a given camera 202A in the set of cameras 202 receives a list of objects observed by the other cameras 202B, 202C, 202D and only transmits data to the server that describes the visibility of said objects. Accordingly, in the example of FIG. 6, both cameras 202A and 202B only transmit the portions of their respective frustrums 602 and 604 containing the polytopes 608. As used above and herein, a polytope refers to a geometric object with flat faces. Accordingly, “polytope” is a term that refers to a set of geometric shapes, and “frustrum” is a term that refers to a specific subset of polytopes.

In some examples, a given camera 202A receives an updated list of objects in response to one or more of the other cameras 202B, 202C, 202D changing configurations (e.g., changing PTZ parameters).

By determining which regions of image data to transmit, the cameras 202 implicitly perform surface to surface matching, thereby overcoming deficiencies exhibited by other approaches that attempt to perform wide base line stereo operations at large distances. Accordingly, the teachings of this disclosure may support the development of 3D models with less time and at longer camera ranges than other approaches.

FIG. 7A is a block diagram of an example implementation of the shape condenser circuitry of FIG. 3. FIG. 7A includes example quad creator circuitry 702, example geometric tester circuitry 704, example tree truncation circuitry 706, and example frame format circuitry 707. FIG. 7B is an illustrative example of operations performed by the shape condenser circuitry as described in connection with FIG. 7A. FIG. 7B includes example pixels 708, example quadrants 710, and example weights 712. FIG. 7C is an illustrative example of operations performed by the shape condenser circuitry as described in connection with FIG. 7A. FIG. 7C includes example segmented quads 714, an example truncated quadrant tree 716, an example polytope 718, and an example TCP/IP frame 720.

The bitmask provided by the segment creator circuitry 306A of FIG. 3 is composed of the pixels 708. Within the bitmask, the object 206 of FIG. 2A is identifiable based on individual pixels 708 being assigned to the foreground or background. The bitmask allows the quad creator circuitry 702 to extract connected components (herein after referred to as groups) as defined in Equation (5):

$${θ}_{q} = \{ ( {u}_{1} , {v}_{1} ) , … , ( {u}_{d} , {v}_{d} ) \} \qquad ( 5 )$$

As used in Equation (5) and herein, θ_{q} refers to the groups formed by d pixels, where u and v are the coordinates of a given pixel. In some examples, the groups θ_{q} may also be referred to as bitmask portions. The d pixels are contained in a region of interest, γ, which is defined in Equation (6):

$$\hat{Υ} ( {θ}_{q} ) = [ {u}_{0} : {min}_{1 \leq i \leq d} ( {u}_{i} ) , {v}_{0} : {min}_{1 \leq i \leq d} ( {v}_{i} ) , {u}_{1} : {max}_{1 \leq i \leq d} ( {u}_{i} ) , {v}_{1} : {max}_{1 \leq i \leq d} ( {v}_{i} ) ] \qquad ( 6 )$$

Equation (6) indicates that the quad creator circuitry 702 selects pixels from the bitmask such that group θ_{q} has a Region Of Interest (ROI) center given in Equation (7):

$$[ {u}_{c} : \frac{1}{2} ( {u}_{1} + {u}_{0} ) , {v}_{c} : \frac{1}{2} ( {v}_{1} + {v}_{0} ) ] \qquad ( 7 )$$

The quad creator circuitry 702 modulates a bounding box in the image to a size that is a power of 2. In doing so, the box can be captured in a quad-tree representation that compresses data without losing levels of detail (e.g., non-lossy compression). In some examples, the length of the maximal quad or root of the subtree for a given foreground patch is referred to as a modulated spawn. The quad creator circuitry 702 selects pixels from the bitmask such that group θ_{q} has a modulated spawn, l, given by Equation (8):

$$l : {2}^{max ( ⌈ {log}_{2} ( {u}_{1} - {u}_{0} ) ⌉ , ⌈ {log}_{2} ( {v}_{1} - {v}_{0} ) ⌉ ) - 1} \qquad ( 8 )$$

The ROI center of Equation (7) and the modulated spawn of Equation (8) are centers in a power 2 square bounding box, Y, given by Equation (9):

$$Υ ( {θ}_{q} ) = [ \overleftarrow{{u}_{0}} : ( {u}_{c} - l ) , \overleftarrow{{v}_{0}} : ( {v}_{c} - l ) , \vec{{u}_{1}} : ( {u}_{c} + l ) , \vec{{v}_{1}} : ( {v}_{c} + l ) ] \qquad ( 9 )$$

In some examples, the coordinates [ [symbol] , \vec{u₁}, \vec{v₁}] from Equation (9) are outside the bitmask. In such examples, the bounding box with side l is outside the image limit. Such a bounding box does not negatively impact compression. Accordingly, the quad creator circuitry 702 and geometric tester circuitry 704 may use the coordinates of Equation (9) to create a quadrant tree representation that is both compressive and unifying.

To create the quadrant tree representation, the example shape condenser circuitry 308A uses a) the bitmask described above (which may be referred to herein as image mask I_{M} (u, v)), b) the PDFs of the corresponding pixels (which may be referred to as density image I_{δ}(u, v)), c) the collection of extracted groups {θ_{q}}, d) the raw \hat{γ}(θ_{q}) bounding boxes of the groups, and e) the modulated bounding boxes γ(θ_{q}) of the groups, to filter and encode the groups. The shape condenser circuitry 308A filters and encodes the groups {θ_{q}} to transmit a subset of the groups to the server 204A for multiple view polycell probabilistic reconstruction.

The recursive quadrant tree technique described herein can be characterized in three phases. In the first phase, the pixels 708 in the mask image I_{M} are called pixel-density shapes, Φ, defined in Equation (10):

$$Φ := [ ( u , v ) , {I}_{δ} ( u , v ) ] \qquad ( 10 )$$

A given pixel-density shape from Equation (10) satisfies I_{M} (u, v) [symbol] 1 (e.g., the pixel at coordinates u, v, was assigned to the foreground) and Is(u, v)>∈ (e.g., the PDF of the pixel at coordinates u, v, indicated the pixel had a foreground probability above a threshold E). Accordingly, the quad creator circuitry 702 initializes a density quadrant tree, Γ, with four quads in the locations given by Equation (11):

$$\{ Γ ← \{ {q}_{0} : [ \overleftarrow{{u}_{0}} , \overleftarrow{{v}_{0}} , \overleftarrow{{u}_{0}} + l \cdot {2}^{- h} , \overleftarrow{{v}_{0}} + \frac{l}{2} ] , {q}_{1} : [ \overleftarrow{{u}_{0}} + l \cdot {2}^{- h} , \overleftarrow{{v}_{0}} , \vec{{u}_{1}} , \overleftarrow{{v}_{0}} + l \cdot {2}^{- h} ] , {q}_{2} : [ \overleftarrow{{u}_{0}} , \overleftarrow{{v}_{0}} + \frac{l}{2} , \overleftarrow{{u}_{0}} + l \cdot {2}^{- h} , \vec{{v}_{1}} ] , {q}_{3} : [ \overleftarrow{{u}_{0}} , \overleftarrow{{v}_{0}} + l \cdot {2}^{- h} , \vec{{u}_{1}} , \vec{{v}_{1}} ] \} \qquad ( 11 )$$

A given quad q_{k,h}, may contain the pixel-density shapes Φ and two additional attributes. The first attribute is an occupancy ratio, π, which represents the cardinality of pixel-density shapes |{Φ}| in the quad q_{k,h}. The occupancy ratio is given by Equation (12):

$$Π ( {q}_{k} , h ) = \vert \{ Φ \} \vert \cdot \frac{{l}^{2}}{{2}^{h}} ; h \geq 0 \qquad ( 12 )$$

In Equation (12),

$$\frac{{l}^{2}}{{2}^{h}}$$

is the area of the quad at level h of the quadrant tree, where h may be any positive integer. The second attribute contained within a quad q_{k,h} is a density dispersion Σ. Density dispersion characterizes the range of intensity values and is defined in Equation (13):

$$\sum ( {q}_{k , h} ) = max ( {I}_{δ} ( u , v ) ) - min ( {I}_{δ} ( u , v ) ) : ∀ ( u , v ) ∈ {q}_{k , h} ) \qquad ( 13 )$$

The quad creator circuitry 702 may split one or more of the quads q_{k∈{1,2,3,4},h} at level h into its four child quads q_{k∈{1,2,3,4},h+1}. In doing so, the quad creator circuitry adds a level h+1 to the quadrant tree. Before splitting the one or more quads, the geometric tester circuitry 704 performs the second phase of the recursive quadrant tree process. For example, the geometric tester circuitry 704 conducts a geometric test to measure the level of interaction between the quad and the fields of view from the other cameras 202 obtained from the server 204. As used herein, a quad interacts with a field of view when a portion of the space within the quad overlaps with the field of view (e.g., a region of camera visibility described as ψᵢ^{t}(αₜⁱ, βₜⁱ, kₜⁱ, T_{GCS}ⁱ) in FIG. 6). A given quad may interact with the fields of view from any number of the cameras 202.

In some examples, the geometric tester circuitry 704 prevents the quad creator circuitry 702 from splitting a quad into smaller quads if the smaller quads would be empty (e.g., without a corresponding polytope-region). A quad has a corresponding polytope-region (and is therefore not empty) if at least a portion of the quad interacts with the one field of view from the other camera 202. The foregoing geometric test reduces the amount of further local and remote computations within the clique of FIG. 2A and enables compact marshalling of the density-pixel objects, thereby supporting complexity reduction.

To marshal density-pixel objects, the geometric tester circuitry 704 creates a single-camera polytope as given in Equation (14):

$${∧}_{k ∈ φ ( {λ}_{i} )} ( {ψ}_{k ,}^{t} {ψ}_{i} ( {q}_{k , h} ) ) ↦ \{ 1 , 0 \} \qquad ( 14 )$$

In Equation (14), ψᵢ (q_{k,h}) is a single-camera polytope created using local camera node ψᵢ parameters. In the third phase of the recursive quadrant tree technique, the geometric tester circuitry 704 checks to see if the other cameras 202 have changed fields of view as described above in connection with FIG. 6. If a change of view has occurred, the geometric tester circuitry 704 forms an update message with the new pose of the frustum (using, for example, a world coordinate system) to all of the cameras 202 that are sharing field of view. The update message is sent to: a) the cameras 202 that now (e.g., in view of update) share a field of view, and b) the cameras 202 which have lost the intersecting views. Accordingly, the geometric test remains feasible for only the cameras 202 that have the updated shared field of view. Without such an update message, the cameras 202 may return inconsistent intersections and/or non-representative polytopes. The geometric tester circuitry 704 recursively checks the geometric feasibility of quads at each level within the quadrant tree.

The recursive quadrant tree technique described herein includes a stop condition that ends the quad splitting operations before the single pixel level. The stop condition is defined by three disjunctive factors. First, the geometric tester circuitry 704 prevents further splitting if

$$\frac{{l}^{2}}{{2}^{h + 1}} < p$$

(e.g., a minimal pixel area is below a threshold). In some examples, minimal pixel area may be referred to as quad size. Second, the geometric tester circuitry 704 prevents further splitting if Π(qₖ, h)>b (e.g., a maximal pixel-density is above a threshold). In some examples, pixel-density may be referred to as quad-boundness. Third, the geometric tester circuitry 704 prevents further splitting if Σ(qₖ)<c (e.g., the quad density-dispersion is below a threshold).

By implementing the recursive quadrant tree technique described above in accordance with the teachings of this disclosure, the quad creator circuitry 702 and the geometric tester circuitry 704 produce a quadrant tree F of quads, where the pixels within a quad have approximately the same probability of being in the foreground and the quads are positioned on the tree according to their probabilities (e.g., quads with higher probabilities are towards the base/root of the tree, while quads with lower probabilities are towards the leaves of the tree). For example, the quadrant tree Γ leaves expose Σ(qₖ)<ε quasi-homogeneous foreground density with high boundness Π(qₖ, h)>b and maximized area

$$\frac{l}{{2}^{h + 1}} > p$$

producing ultra-compact repetitions.

The example tree truncation circuitry 706 receives a full quadrant tree Γ and removes quads from the tree. For example, the tree truncation circuitry 706 removes quads with a mean probability of being in the foreground that is below a given threshold. The removed quads are at or near the leaves of the tree because the quads are positioned within the tree based on the probability of being in the foreground. In some examples, the tree truncation circuitry 706 reduces the number of quads in the tree to a degree that the remaining objects can be transmitted to the server 204 in a single TCP/IP packet.

The data compression that occurs from the shape condenser circuitry 308A is visualized in FIGS. 7B and 7C. In the example of FIG. 7B, there are 59,548 of the pixels 708 within the bitmask provided by the segment creator circuitry 306A. In contrast, there are 928 of the quadrants 710. The quadrants 710 includes all the quadrants from the full quadrant tree Γ and are positioned based on the location of the original pixels 708 that form said quadrants. The weights 712 represent the probability of the quadrants 710 belonging to the foreground. In the example of FIG. 7B, the weights are patterned with dots such that, in general, quadrants with higher probabilities have fewer dots while quadrants with lower probabilities have more dots. Quadrants with higher probabilities also contain a larger area than quadrants with lower probabilities because the geometric test allows fewer divisions of quadrants that intersect with fields of view from other cameras (e.g., quadrants that are in the foreground of multiple cameras).

Example operations of the tree truncation circuitry 706 are visualized in FIG. 7C with the segmented quads 714 and the truncated quadrant tree 716. The segmented quads 714 are a subset of the quadrants 710 and contain only those quadrants remaining on the truncated quadrant tree 716. In the example of FIGS. 7B and 7C, there are 99 quads within the truncated tree. The reduction from 59,548 pixels to 99 quads results in a 601.49x compression factor.

The shape condenser circuitry 308A reduces data to be transmitted and regularizes the tradeoff between modeled joint shape-acutance and density-spread tradeoff. The result is a mean density per quad, ζ_{q}, denoted by Equation (15):

$${ζ}_{q} = \frac{1}{\vert {q}_{k , h \vert}} {\sum }_{( u , v ) ∈ {q}_{k , h}} {I}_{δ} ( u , v ) \qquad ( 15 )$$

A given quad within the truncated quadrant tree 716 represents a portion of a frustrum (e.g., a polytope) as described above in connection with FIGS. 5 and 6. For example, while the polytope 718 represents the region of visibility common across the cameras 202, the server 204 can use the truncated quadrant trees 716 of multiple cameras to determine smaller polytopes specific to the object 206.

The frame format circuitry 707 encodes the truncated tree within the TCP/IP frame 720 and transmits the frame to the server 204. In the example of FIGS. 7B and 7C, the 99 segmented quads are described within the TCP/IP frame 720 using 501 bytes. For a given segmented quad, twelve bits describe the x coordinate of a corner of the quad, twelve bits describe the y coordinate of the corner, and sixteen bits describe the length of the square (which is proportional to the mean confidence value of the quadrant). In some examples, the frame format circuitry 707 may use a different format that results in a different encoding ratio between the number of segment quads and the number of corresponding bytes.

The example shape condenser circuitry 308A enables the camera 202A to transfer uncertainty-aware segmentation information of a detailed and consistent density-group within a TCP/IP frame. The teachings of this disclosure support high-reliability transmission, minimal-distributed computation, and scene relevance guarantees (with respect to the polytope intersection) among cameras in a clique. Furthermore, the shape condenser circuitry 308A is implemented on the camera 202A, making the subsequent aggregation process on the server 204 computationally lighter. This reduction in complexity at the server 204 results in scalability and economic value for applications performing time critical inferences using 3D models that are generated by cameras from long ranges.

FIG. 8A is a block diagram of an example implementation of the model manager circuitry 316 of FIG. 3. The model manager circuitry 316 includes example polycell generator circuitry 802, example probability normalizer circuitry 804, and example polycell selector circuitry 806. FIG. 8B is an illustrative example of operations performed by the model manager circuitry as described in FIG. 8A. FIG. 8B illustrates an example polycell computation 808, an example untextured model 810, and an example textured model 812.

Within the example model manager circuitry 316, the polycell generator circuitry 802 obtains density-quads qₖ (e.g., the quads remaining on the truncated quadrant trees 716) from multiple camera nodes λᵢ (e.g., the cameras 202). The polycell generator circuitry 802 then processes the intersection(s) of the obtained density-quads in a hierarchical manner as given in Equation (16):

$$∧ ( {ψ}_{i} ( {q}_{k , h} ) , {ψ}_{j} ( {q}_{k , h} ) ) ↦ {ψ}_{i ∧ j , h}^{t} \qquad ( 16 )$$

Equation (16) states that a smaller polytope ψ_{i∧j,h}^{t} can be defined by the intersection of at least two quads (e.g., larger polytopes). For example, the smaller polytope ψ_{i∧j,h}^{t} has an associated density (e.g., probability of existing within the object 206), ζ_{q,i∧j}, given by Equation (17):

$${ζ}_{q , i ∧ j} = {ζ}_{q , i} \cdot {ζ}_{q , j} \leq max ( {ζ}_{q , i} \cdot {ζ}_{q , j} ) \qquad ( 17 )$$

When integrating another camera view besides those from λᵢ and λⱼ, the polycell generator circuitry 802 conducts an intersection operation upon ψ_{i∧j,h}^{t} if ζ_{q,i∧j}>δ₂. That is, the polycell generator circuitry 802 conducts an intersection operation (thereby creating a new, smaller polytope) if the combined density of the current polytope is above the minimal density threshold δ₂.

The coordinated spatial and density reduction performed by the polycell generator circuitry 802 ensures the volumetric intersections are significant while also modeling the rapid decay in the density to avoid rejection of polycells with large confidence values. As used above and herein, a polycell (which herein after may be expressed algebraically as ψ^{t}_{i∧j∧k∧m . . . ∧n,w}) refers to the intersection of polytopes from multiple cameras (i ∧j ∧k ∧m . . . ∧n) such that the combined density, δ_{w}, is above a minimum threshold.

The operations of the polycell generator circuitry 802 are visualized in FIG. 8B with the polycell computation 808. Conceptually, a polycell may be referred to as a generalization of voxels (e.g., a value on a regular grid in three-dimensional space). Voxels are delimited by six axis-aligned planes.

In some examples, polycells produced by the model manager circuitry 316 have a bounded volume that is limited by (4≤m<∞) oriented planes describing non-orthogonal faces. Within the context of FIG. 5, the near and far planes (ϕ₅₁₂ⁱ and ϕ₅₁₄ⁱ, respectively) describe resolution requirements and are not necessarily geometric constrains. Accordingly, some examples may geometrically define a polycell using a minimum of four non-orthogonal faces as described above rather than the six faces of FIG. 5. However, the use of additional planes in a polycell definition generally reduces the volume of the polycell and results in a more detailed model.

To compute a polycell shaping complex, the polycell generator circuitry 802 evaluates the inequality in Equation (18):

$$P x > h \qquad ( 18 )$$

In Equation 18, P∈ R^{m×3} is stacked matrix of normal vectors representative of the directions of the planes (e.g., as illustrated above in FIG. 5). Equation (18) also includes x, which represents a particular point in space, and h∈ R^{m}, which is a vector denoting the distance between planes. In the example of FIG. 8A, the polycell generator circuitry 802 uses the Hesse normal form to determine the distances denoted in h. In such examples, distances between planes may be referred to as Hesse distances. In some examples, the polycell generator circuitry 802 uses a different technique to evaluate the distance between two planes.

To evaluate Equation (18), the polycell generator circuitry 802 multiplies the point x with the matrix P, which describes the bounding planes of two or more quads (e.g., polytopes) from the truncated quadrant trees 716. If the result of the matrix multiplication is greater than the distance between the planes, then the point x lies within the bounding planes and therefore is part of the polycell. Similarly, if the result of the matrix multiplication is greater than the distance between the planes, then the point x lies on the face of one of the bounding planes and therefore is part of the polycell. Conversely, if the result of the matrix multiplication is less than the distance between the planes, the point x lies outside of the bounding planes and therefore is not part of the polycell.

The evaluation of Equation (18) enables the polycell generator circuitry 802 to produce polycells that have a bound and finite volume. As such, the polycells may be referred to as closed polytopes encompassing a discrete volumetric object. In some examples, the polycell generator circuitry 802 implements algorithms that evaluate expression (18) in a resource and time efficient matter. For example, the polycell generator circuitry 802 may determine a polycell using eight planes in approximately 745 microseconds (μs). In some examples, the polycell generator circuitry 802 generates a polycell with a different number of planes and/or in a different amount of time. The efficient calculation of polycells enable the model manager circuitry 316 to generate 3D models in real-time or substantially real-time, thereby supporting applications that perform time critical inferences using 3D models. Examples of algorithms used to evaluate Equation (18) include but are not limited to vertex enumeration, any technique to determine an object's vertices given a formal representation of the object, etc..

As the number of intersections used to create a polytope increases, the combined density 6, decays exponentially. For example, if the polycell generator circuitry 802 determines the intersection of a quad having a 50% probability of being in the object 206 (e.g. ζ_{q,i}=0.5) and a quad having an 80% probability of being in the object 206 (e.g. ζ_{q,j}=0.8), the resulting polytope has only a 40% probability of being in the object 206 (ζ_{q∧j}=0.4) because 0.5×0.8=0.4. Accordingly, if a quad from a third camera view is introduced, the polytope of the resulting in intersection will have a probability of being in the object 206 that is less than 40%.

Within the example model manager circuitry 316, the polycell normalizer circuitry 804 performs a volumetric weighted normalization to combine groups of polycells. The normalization includes an integration operation that results in K new polycells with higher confidence values than the original polycells (as discussed above, the original polycells have relatively low confidence values due to the exponential decay).

The K new polycells produced by the polycell normalizer circuitry 804 are also more volumetrically coherent than the original polycells. That is, while the original polycells produced by the polycell generator circuitry 802 are relatively amorphous 3D volumes, the new polycells produced by the polycell normalizer circuitry 804 are 3D volumes that bear closer resemble to an intended shape (e.g., the new polycells may resemble part of a limb from the pedestrian in the object 206).

To perform the weighted normalization operation, the polycell normalizer circuitry 804 first computes the volume of a polycell, Ξ, as given in Equation (19):

$$Ξ ( {ψ}_{i ∧ j ∧ k , ∧ m … ∧ n , w}^{t} ) ↦ {R}^{+} \qquad ( 19 )$$

In Equation (19), R⁺ represents real positive numbers excluding 0. The polycell normalizer circuitry 804 then determines a normalized density per new polycell, \hat{δ}(ψ^{t}_{i∧j∧k∧m . . . ∧n,w}), as defined in Equation (20):

$$\hat{δ} ( {ψ}_{i ∧ j ∧ k , ∧ m … ∧ n , w}^{t} ) = \frac{Ξ ( {ψ}_{i ∧ j ∧ k , ∧ m … ∧ n , w}^{t} ) \cdot {ζ}_{i ∧ j ∧ k , ∧ m … ∧ n , w}^{t}}{{\sum }_{i ∧ j ∧ k , ∧ m}^{K} Ξ ( {ψ}_{i ∧ j ∧ k , ∧ m … ∧ n , w}^{t} ) \cdot {ζ}_{i ∧ j ∧ k , ∧ m … ∧ n , w}^{t}} \qquad ( 20 )$$

The computation of Equation (20) maps the normalized density per new polycell to a value between 0 and 1, as given in Equation (21):

$$0 < \hat{δ} ( {ψ}_{i ∧ j ∧ k , ∧ m … ∧ n , w}^{t} ) \leq 1 \qquad ( 21 )$$

In doing so, the polycell normalizer circuitry 804 improves the contrast between new polycells that come from noisy input data (and therefore have a \hat{δ}(ψ^{t}_{i∧j∧k∧m . . . ∧n,w}) value near 0) and new polycells with a high probability of being in the object 206 (and therefore have a \hat{δ}(ψ^{t}_{i∧j∧k∧m . . . ∧n,w}) value near 1). The polycell normalizer circuitry 804 leverages the foregoing contrast by computing a cumulative distribution (CD) of normalized densities, E, as given in Equation (22):

$$E = η {\sum }_{i ∧ j ∧ k , ∧ m}^{K} \hat{δ} ( {ψ}_{i ∧ j ∧ k , ∧ m … ∧ n , w}^{t} ) \qquad ( 22 )$$

In Equation (22), η represents a cut-off value. For example, f is approximately equal to 0.997 using the empirical rule of a Gaussian distribution.

The polycell selector circuitry 806 selects a subset of the new polycells to produce a 3D model. For example, the polycell selector circuitry 806 selects polycells having a CD of normalized densities above a given threshold \tilde{E}, as given in Equation (23):

$${ζ}_{i ∧ j ∧ k , ∧ m … ∧ n , w}^{t} > {E}^{⌣} \qquad ( 23 )$$

Similarly, the polycell selector circuitry 806 discards any polycells that fail to satisfy Equation (23) from the volumetric model K. By removing polycells having a CD of normalized densities below a threshold, the polycell selector circuitry 806 concludes the joint space density erosion operations and produces an untextured model that is ready to be utilized by various applications for inferences. In the example of FIG. 8, the untextured model 810 describes the object 206 of FIG. 2A.

In some examples, an application makes inferences based on a texturized model. A texturized model refers to a model with color data that enables an application to perform computer vision operations using texture analysis (e.g., texture segmentation, texture synthesis, texture shape extraction, texture classification etc.). For example, an application may use a texturized model to extract human-actions, assert a vehicle's color, analyze the pattern in the hair of livestock, etc.

If an application does require a texture model, the server 204 requests Red-Green-Blue-Alpha (RGBA) color data from one or more of the cameras 202. For example, the server 204 requests a quad ψᵢ(q_{k,h}) that is requested as a sub image I_{rgba}^{i,t}(q_{k,h}), from camera node λᵢ at time t extracted from I_{rgba}(u, v). Within the camera 202A, the segment creator circuitry 306A defines the requested quad and determines the alpha value (e.g., the transparent channel in RGBA data) using the image mask (e.g., the bitmask of FIGS. 4A and 4B) as I_{M} (u, v) [symbol] {0,255}. As used herein, the quad requested by the server 204 and the corresponding RGBA data may be referred to as a quad texture. The cameras 202 determine and transmit the quad textures to the server 204.

The one or more quad textures received by the server 204 from the cameras 202 may overlap and come from diverse views. Accordingly, the server 204 determines a weighted composition, ω̅_{g}, using the surface normal vector for each facet g expressed as ω̅_{g}∈R³: |ω̅_{g}|=1. As used above and herein, a facet refers to a plane resulting from the intersection among planes. Accordingly, the points inside a facet fulfill Equation (18) described above. The server 204 then computes the texture T_{rgba} as provided in Equation (24):

$${T}_{rgba} = \frac{{\sum }_{g ∈ {ψ}_{i ∧ j ∧ k , ∧ m … ∧ n , w}^{t}} max ( L ( {q}_{k , h} ) \cdot {ϖ}_{g , 0} ) {I}_{rgba}^{i , t} ( {q}_{k , h} )}{{\sum }_{g ∈ {ψ}_{i ∧ j ∧ k , ∧ m … ∧ n , w}^{t}} max ( L ( {q}_{k , h} ) \cdot {ϖ}_{g , 0} )} \qquad ( 24 )$$

In Equation (24), L refers to a function that extracts the orientation vector with maximal alignment to ω̅_{g,0} (a weighted composition) associated to the one of the six planes derived from q_{k,h} (a quad). A request for texture is discussed further in connection with FIG. 10. In the example of FIG. 8, the textured model 812 may enable an application to distinguish between the skin, shirt, pants, shoes, etc. of the pedestrian in FIG. 2A.

The example model manager circuitry 316 forms a 3D model using one or more polycells. In some examples, the model manager circuitry 316 forms a polycell by leveraging, from the respective cameras 202: a) collection of 2D quads with density polytopes, b) time-stamped kinematic and optical state (extrinsic and intrinsic parameters) compressed in a time-varying projection matrix as described above. Such data enables the server 204 to efficiently compute the collective hierarchical intersection of polytopes via a parallelized vertex enumeration technique.

While an example manner of implementing the example clique of FIG. 2A is illustrated in FIG. 3, one or more of the objects, processes, and/or devices illustrated in FIG. 3 may be combined, divided, re-arranged, omitted, eliminated, and/or implemented in any other way. Further, the example position matrix circuitry 304A, the example segment creator circuitry 306A, the example shape condenser circuitry 308A, the example network controller circuitry 312, the example user configuration circuitry 314, the example model manager circuitry 316, and/or, more generally, the example cameras 202 and the example server 204 of FIG. 3, may be implemented by hardware alone or by hardware in combination with software and/or firmware. Thus, for example, any of the example position matrix circuitry 304A, the example segment creator circuitry 306A, the example shape condenser circuitry 308A, the example network controller circuitry 312, the example user configuration circuitry 314, the example model manager circuitry 316, and/or, more generally, the example cameras 202 and the example server 204 of FIG. 3, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example cameras 202 and/or the example server 204 of FIG. 3 may include one or more objects, processes, and/or devices in addition to, or instead of, those illustrated in FIG. 3, and/or may include more than one of any or all of the illustrated objects, processes and devices.

Flowchart(s) representative of example machine-readable instructions, which may be executed by programmable circuitry to implement and/or instantiate the cameras 202 and/or the example server 204 of FIG. 3 and/or representative of example operations which may be performed by programmable circuitry to implement and/or instantiate the cameras 202 and/or the example server 204 of FIG. 3, are shown in FIGS. 9-12. The machine-readable instructions may be one or more executable programs or portion(s) of one or more executable programs for execution by programmable circuitry such as the programmable circuitry 1412 shown in the example programmable circuitry platform 1400 discussed below in connection with FIG. 14 and/or may be one or more function(s) or portion(s) of functions to be performed by the example programmable circuitry (e.g., an FPGA) discussed below in connection with FIGS. 15 and/or 16. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 9-12, many other methods of implementing the example clique may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 9-12 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 9 is a flowchart representative of example machine-readable instructions and/or example operations that may be executed, instantiated, and/or performed by example programmable circuitry to implement the clique of FIG. 2A. The example flowchart of FIG. 9 shows two columns of blocks labelled with reference numerals from FIG. 2. Accordingly, blocks in the “204” column are implemented by the example server 204, and blocks in the “202” column are implemented by the cameras 202. In some examples, one or more of the cameras 202A, 202B, 202C, and 202D may independently implement blocks 902, 904, and 906 in parallel with one another.

The example machine-readable instructions and/or the example operations 900 of FIG. 9 begin when the cameras 202 transmit network configuration data to the server 204. (Block 902). As used above and herein, network configuration data refers to parameters that characterize how a given camera 202A communicates over the network. Network configuration data may include but is not limited to a maximum packet size, packet periodicity, etc. The position matrix circuitry 304 within the respective cameras 202 also sends field of view (FOV) data at block 902 as discussed above in connection with FIG. 5.

The network controller circuitry 312 uses the network configuration data to generate a schedule and transmit the schedule to connected polytopes. (Block 904). For example, the user configuration circuitry 314 aggregates the network configuration data from the various cameras 202 and provides the results to the network controller circuitry 312. The network controller circuitry 312 then creates a schedule for cameras with connected polytopes.

In some examples, the schedule created by the network controller circuitry 312 may coordinate and/or synchronize operations between subsets of cameras in a clique with connected polytopes (e.g., subsets of cameras that have overlapping regions of visibility). For example, in FIG. 1, the schedule may instruct the operations of cameras 104B to perform operations in a time-based sequence that is relative to the operations of cameras 104A, 104C, and 104G. In some examples, the schedule may include a pan instruction, a tilt instruction, and/or a zoom instruction that cause one or more of the cameras 202 to change fields of view.

After forming the schedule, the network controller circuitry 312 transmits the schedule to the cameras 202 in a Gate Control List (GCL) configuration. GCL configurations are discussed further in connection with FIG. 13. The network circuitry may also send an incident list (e.g., a list of cameras 202 in the clique) to the respective cameras 202A, 202B, 202C, 202D at block 904.

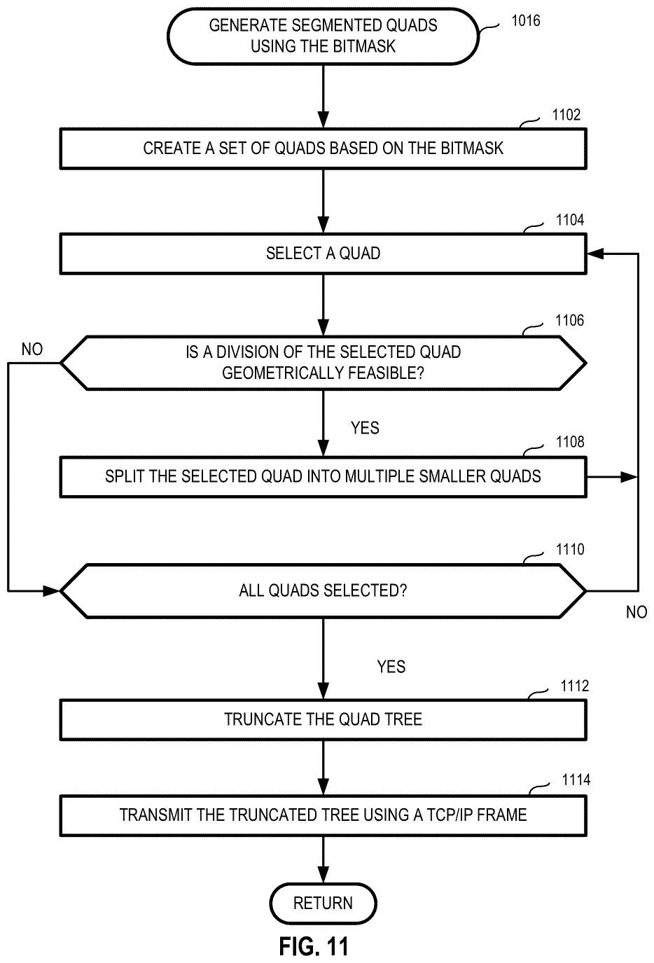

The cameras 202 generate segmented quads and transmit the quads to the server 204 (Block 906). To do so, a given camera 202A captures images in a time-sensitive manner based on the schedule, forms a bitmask of the foreground, and compresses the pixels within the bitmask into quads as discussed above in connection with FIGS. 4A, 4B, 7A, 7B, and 7C. Block 906 is also discussed further in connection with FIGS. 10 and 11.

In some examples, a camera may not transmit quads at block 906 if the camera does not have an intersecting field of view with any of the other cameras within the clique (and therefore cannot provide information useful for 3D modeling). In such an example, the camera without an intersecting field of view can determine it is not necessary to transmit quads to a server by, as described above, comparing the frustrum that defines it region of visibility to frustrums defining the regions of visibility of other cameras.

The server 204 generates an untextured model based on the segmented quads. (Block 908). To do so, the model manager circuitry 316 determines polycells based on the intersection of polytopes, normalizes the polycells, and selects a subset of polycells as discussed above in connection with FIGS. 8A and 8B. Block 908 is also discussed further in connection with FIG. 12.

The server 204 determines whether applications that receive the 3D model receive textures for inference. (Block 910). Inferences based on textures may include but are not limited to classifying human actions, asserting a vehicle's color, analyze the pattern in the hair of livestock, etc. If textures are not used for inference (Block 910: No), control proceeds to block 916.

If textures are used for inference, the server 204 transmits an updated incident list and texture requests to the cameras 202. (Block 912). The texture requests refer to a request for RGBA data from a sub image of a particular camera and image as described above in connection with FIGS. 8A and 8B.

The cameras 202 determine textured quads based on the request and transmit the quads to the server 204. (Block 914). To do so, a given camera 202A obtains the RBG data from a copy of the requested sub image that was not desaturated. The camera 202A also determines the requested alpha value using the bitmask of block 906.

The server 204 adds weights the textured quads from the various cameras 202 relative to one another (e.g., marks some textures as more relevant than others). The server 204 then uses the weight values to apply a texture to the model as described above in connection with Equation (24).

After texturing the model, or if the application does not use textures for inference (Block 910: No), the server 204 provides the model to the application. (Block 916). The application may be implemented by any number of devices on the edge network and may use the model to perform any kind of inference. The example machine-readable instructions and/or example operations 900 end after block 916.

The example flowchart of FIG. 9 and foregoing description refer to a single 3D model that may be generated in response to images being captured at a single point in time. In some examples, a clique implemented in accordance with the teachings of this disclosure may continuously implement the example machine-readable instructions and/or example operations 900, thereby producing a 3D model that can update whenever additional images are captured.

FIG. 10 is a flowchart representative of example machine-readable instructions and/or example operations that may be executed, instantiated, and/or performed by example programmable circuitry to generate and transmit segmented squads as described in FIG. 9. For example, the flowchart of FIG. 10 is an example implementation of block 906 of FIG. 9. In some examples, one or more of the cameras 202 may independently implement the flowchart of FIG. 10 in parallel with one another.

The implementation of block 906 begins when the example segment creator circuitry 306A of FIG. 4 accesses an image. (Block 1002). The image of block 1002 is captured using the sensor circuitry 402, which may implement any type of optical sensor.

The example histogram circuitry 406 of FIG. 4 updates histograms with intensity values based on the image. (Block 1004). A given histogram tracks the intensity of a pixel coordinate over time (e.g., over a sequence of images). In some examples, the histogram circuitry 406 additionally or alternatively tracks the hue of pixel coordinates over time.

The PDF estimator circuitry 408 determines the likelihood of the newest data point being part of the background. (Block 1006). For example, the PDF estimator circuitry 408 evaluates a Gaussian kernel density function and compares the output of the function to an integral of data points surrounding the given pixel, as described above in connection with FIGS. 4A and 4B. By doing so, the segment creator circuitry 306A creates a PDF describing the likelihood of a particular pixel being in the background at block 1006.

The adaptive binarization circuitry 410 selects a pixel. (Block 1008). The adaptive binarization circuitry 410 then uses the PDF of block 1006 to determine if the probability of a particular pixel being in the background is below a threshold. (Block 1010). If the probability is above the threshold (Block 1010: No), control proceeds to block 1014.

If the probability of the selected pixel is below the threshold (Block 1010: Yes), the adaptive binarization circuitry 410 adds the selected pixel to a bitmask. (Block 1012). By adding the pixel to the bitmask, the adaptive binarization circuitry 410 assigns the pixel to the foreground. Similarly, by excluding a pixel from the bitmask, the adaptive binarization circuitry 410 assigns the pixel to the background.

The adaptive binarization circuitry 410 determines whether there is another pixel to analyze in the image. (Block 1014). If there is another pixel from the image of block 1002 to analyze (Block 1014: Yes), control returns to block 1008 where the adaptive binarization circuitry 410 selects another pixel. In the example of FIG. 9, the camera 202A implements a one-to-one correspondence between images captured at block 1002 and creation of a bitmask (e.g., the execution of blocks 1008-1014). In some examples, camera 202A implements a different ratio between the number of bitmask updates per image and pixel created.

In the example of FIG. 9, the adaptive binarization circuitry 410 creates a bitmask by implementing blocks 1008-1014. In some examples, the adaptive binarization circuitry 410 updates an existing bitmask rather than a creating a new bitmask. In such examples, the adaptive binarization circuitry 410 may remove a pixel from an old version of the bitmask if the updated probability of said pixel being in the background is above a threshold (e.g., block 1010: No).

If the adaptive binarization circuitry 410 has analyzed all the pixels from the image of block 1002 (Block 1014: No), the shape condenser circuitry 308A generates segmented quads using the bitmask. (Block 1016). As used above and herein, segmented quads refer to an example implementation of the truncated quadrant tree 716 of FIG. 7B. Block 1016 is discussed further in connection with FIG. 11. The example machine-readable instructions and/or example operations 900 return to block 908 after block 1016.

FIG. 11 is a flowchart representative of example machine-readable instructions and/or example operations that may be executed, instantiated, and/or performed by example programmable circuitry to implement the shape condenser circuitry of FIG. 3. FIG. 11 is an example implementation of block 1016 of FIG. 10 to generate segmented quads. In some examples, one or more of the cameras 202 may independently implement the flowchart of FIG. 11 in parallel with one another.

The execution of block 1016 begins when the example quad creator circuitry 702 creates a set of quads based on the bitmask of FIG. 9. (Block 1102). To do so, the quad creator circuitry 702 forms groups of pixels within the bitmask as discussed above in connection with Equations (5)-(9). The quad creator circuitry 702 then divides the groups into quadrants, where a given quadrant includes pixel density shapes, an occupancy ratio, and a density dispersion as discussed above in connection with Equations (11)-(13).

The example geometric tester circuitry 704 selects a quad. (Block 1104). The example geometric tester circuitry 704 then determines if a division of the selected quad is geometrically feasible. (Block 1106). To determine if a quad is geometrically feasible, the geometric tester circuitry 704 measures the interaction between the selected quad and the fields of view from the other cameras 202 obtained from the server 204. The geometric tester circuitry 704 may determine a division of the selected quad is not geometrically feasible if: (a) the quad size of the selected quad is below a threshold value, (b) the quad-boundness is above a threshold, or (c) the density dispersion of the selected quad is below a threshold, as discussed above in connection with FIGS. 7A, 7B, and 7C.

If the geometric tester circuitry 704 determines a division of the selected quad is geometrically feasible (Block 1106: Yes), the quad creator circuitry 702 splits the selected quad into multiple smaller quads. (Block 1108). The splitting of a quad involves the splitting of the group of pixels into smaller groups, the updating of the occupancy ratio values, and the updating of the density dispersion values. After splitting the quads, the quad creator circuitry 702 adds the smaller quads to a quadrant tree. The quadrant tree characterizes the relationship between the quads based on their size (which is proportional to the probability of the quad being in the foreground) and the location within the bitmask. After block 1108, control returns to block 1104 where the geometric tester circuitry 704 selects another quad.

Alternatively, if the geometric tester circuitry 704 determines a division of selected the quad is not geometrically feasible (Block 1106: No), the geometric tester circuitry 704 determines whether all quads have been selected. (Block 1110). If all quads have not been selected (Block 1110: No), control returns to block 1104 where the geometric tester circuitry 704 selects another quad.

If all quads have been selected (Block 1110: Yes), the tree truncation circuitry 706 truncates the quadrant tree created across blocks 1104 and multiple iterations of block 1108. (Block 1112). The tree truncation circuitry 706 removes quads at or near the leaves of the quadrant tree based on the quads having a mean probability of being in the foreground that is below a given threshold. By removing quads, the tree truncation circuitry 706 produces the truncated quadrant tree 716 of FIG. 7B.

The frame format circuitry 707 transmits the truncated tree using a TCP/IP frame. (Block 1114). In some examples, the frame format circuitry 707 encodes the truncated quadrant tree 716 using twelve bits to describe x coordinates of the quads, twelve bits to describe y coordinates of the quads, and sixteen bits to describe length values of the squares. In some examples, the frame format circuitry 707 may use a different format to encode the truncated quadrant tree 716. The example machine-readable instructions and/or example operations 900 return to block 908 after block 1114.

FIG. 12 is a flowchart representative of example machine-readable instructions and/or example operations that may be executed, instantiated, and/or performed by example programmable circuitry to implement the model manager circuitry of FIG. 3. For example, the flowchart of FIG. 12 is an example implementation of block 908 of FIG. 9 to generate an untextured model.

Implementation of block 908 begins when the example polycell generator circuitry 802 of FIG. 8 selects two quads with overlapping fields of view. (Block 1202). The two quads are from two instances of the truncated quadrant tree 716 that were received by the server 204. The two quads may correspond to any of the cameras 202.

The polycell generator circuitry 802 computes a polycell based on the intersection of the selected quads. (Block 1204). For example, the polycell generator circuitry 802 evaluates Equation (18) by adding a given point in space, x, to the polycell if the multiplication of the point with a stacked matrix of normal plane vectors is greater than the distance between the planes. The polycell that results from Equation (18) has a smaller volume than either input polytope. The resulting polycell also has an associated density discussed above in Equation (17).

The polycell generator circuitry 802 determines whether the combined density of an additional overlapping quad would satisfy a density threshold. (Block 1206). The polycell generator circuitry 802 implements block 1206 whether there is an additional quad that intersects the current polytope by any portion. The polycell generator circuitry 802 then determines if a polycell formed by the intersection would have a probability of being in the foreground above a threshold value. The polycell generator circuitry 802 determines the probability of a polycell being in the foreground by multiplying the probabilities of the input quads to one another.

If the polycell generator circuitry 802 determines the combined density of an additional overlapping quad would satisfy a density threshold (Block 1206: Yes), the polycell generator circuitry 802 updates the polycell based on the additional overlapping quad. (Block 1208). That is, the polycell generator circuitry 802 computes an intersection of the previous version of the polycell and the additional quad. After block 1208, control returns to block 1206 where the polycell generator circuitry 802 determines whether the combined density of another overlapping quad would satisfy a density threshold.

If the polycell generator circuitry 802 determines there are no further overlapping quads, or that the combined density of an additional overlapping quad would not satisfy a density threshold (Block 1206: No), the polycell generator circuitry 802 determines whether all quads received from the cameras 202 for a given time stamp have been selected. (Block 1210). The polycell generator circuitry 802 may select a quad to form a new polycell (e.g., at block 1202) or to update an existing polycell (e.g., at block 1208). If all quads for a given timestamp have not been selected (Block 1210: No), control returns to block 1202 where the polycell generator circuitry 802 selects additional quads having overlapping fields of view.

If all quads for a given timestamp have been selected (Block 1210: Yes), the polycell normalizer circuitry 804 normalizes the probability density of the polycells. (Block 1212). The normalization includes an integration operation that results in K new polycells with higher confidence values than the original polycells of blocks 1204 and 1208. For example, the polycell normalizer circuitry 804 implements Equations (19), (20), and (21) as discussed above in connection with FIGS. 8A and 8B. The polycell normalizer circuitry 804 also increases the volumetric coherence of the original polycells by normalizing the probability density.

The polycell normalizer circuitry 804 computes the cumulative distribution function (CDF) of the normalized polycells. (Block 1214). To compute the CDF of a given polycell, the polycell normalizer circuitry 804 implements Equation (22) by adding the normalized probability densities of the input quads that formed the polycell.

The polycell selector circuitry 806 selects the polycells that have a CDF above a threshold. (Block 1216). Accordingly, the selected polycells have a minimum probability of belonging to the object 206. The set of polycells selected at block 1216 collectively form an untextured model. The example machine-readable instructions and/or example operations 900 return to block 910 after block 1216.

FIG. 13 is an illustrative example of traffic scheduling that may be performed by the server of FIG. 2A to implement the communications of FIG. 12. FIG. 13 includes an example GCL configuration 1302 and an example table 1304.

The GCL configuration 1302 is an example of how the cameras 202 may implement a schedule provided by the network control circuitry. In the example of FIG. 13, the period T refers to the amount of time required to generate or update a 3D model using images captured at one point in time. For example, in the flowchart of FIG. 9, the period T of FIG. 13 would span from the beginning of block 906 to the end of block 914.

The GCL configuration 1302 marks the period T with time stamps t₀+δ, t₁+δ, and t₂+δ. Between t₀+δ and t₁+δ, a given camera may transmit messages from a best effort queue implemented in local memory to the server 204. Messages saved in the best effort queue contain information that is not time critical but should be communicated to the server eventually. Examples of messages stored in the best effort queue may include but is not limited to the communication of parameters such as battery level, external/internal temperature, shutter speed, International Organization for Standardization (ISO) setting, commands to change camera configuration, etc.

In contrast, messages stored in the time critical queue of the camera 202A are time sensitive (e.g., used to support applications forming real-time or substantially real-time inferences). Examples of messages stored in the time critical queue may include but is not limited to the TCP/IP frame containing a truncated tree, RGBA data from a texture request, etc. Accordingly, the clique prioritizes the exchange of messages from time critical queues over the exchange of messages from best effort queues. The GCL configuration 1302 indicates a given camera transmits messages from the time critical queue between t₁+δ and t₂+δ.

The example table 1304 is an example of GCL parameters values that the cameras 202 may implement. That is, the table 1304 includes values of δ, t₀, t₁, and t₂ for the respective cameras 202. In other examples, cameras may include different GCL parameter values than those shown in FIG. 13.

The example table 1304 illustrates how the cameras 202 prioritize messages from the time critical queues over the best effort queues. For example, the table 1304 shows in the camera 202A δ=0 ms, t₀=0 ms, t₁=0.1 ms, and t₂=33 ms for the camera 202A. In such an example, the camera 202A can transmit any information currently present within the time critical queue during the first 0.1 ms of T. The camera 202A uses the remaining 32.9 ms of period T to transmit from the best effort queue.

The table 1304 also illustrates how the GCL parameter values are configurable based on the characteristics of a particular camera. For example, the portion of T in which camera 202A transmits data from its time critical queue (0.1 ms) is less than the portion of T during which camera 202D transmits data from its time critical queue (2 ms). Such a difference is possible because the camera 202A has a wired connection to the server 204, which support a relatively high bandwidth when compared to the wireless connection of camera 202D.

FIG. 14 is a block diagram of an example programmable circuitry platform 1400 structured to execute and/or instantiate the example machine-readable instructions and/or the example operations of FIGS. 9-12 to implement the clique of FIG. 3. The programmable circuitry platform 1400 can be, for example, a server, a personal computer, a workstation, a self-learning machine (e.g., a neural network), a mobile device (e.g., a cell phone, a smart phone, a tablet such as an iPad™), an Internet appliance, a set top box, a headset (e.g., an augmented reality (AR) headset, a virtual reality (VR) headset, etc.) or other wearable device, or any other type of computing and/or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, and/or microcontrollers from any desired family or manufacturer. The programmable circuitry 1412 may be implemented by one or more semiconductor based (e.g., silicon based) devices. In this example, the programmable circuitry 1412 implements the position matrix circuitry 304A, the segment creator circuitry 306A, and/or the shape condenser circuitry 308A within the camera 202A. The programmable circuitry 1412 may additionally or alternatively implement the network controller circuitry 312, the user configuration circuitry 314, and/or the model manager circuitry 316 within the server 204.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter data and/or commands into the programmable circuitry 1412. The input device(s) 1422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1400 of the illustrated example also includes one or more mass storage discs or devices 1428 to store firmware, software, and/or data. Examples of such mass storage discs or devices 1428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1432, which may be implemented by the machine-readable instructions of FIGS. 9-12, may be stored in the mass storage device 1428, in the volatile memory 1414, in the non-volatile memory 1416, and/or on at least one non-transitory computer readable storage medium such as a CD or DVD which may be removable.

FIG. 15 is a block diagram of an example implementation of the programmable circuitry 1412 of FIG. 14. In this example, the programmable circuitry 1412 of FIG. 14 is implemented by a microprocessor 1500. For example, the microprocessor 1500 may be a general-purpose microprocessor (e.g., general-purpose microprocessor circuitry). The microprocessor 1500 executes some or all of the machine-readable instructions of the flowcharts of FIGS. 9-12 to effectively instantiate the circuitry of FIG. 2 as logic circuits to perform operations corresponding to those machine-readable instructions. In some such examples, the circuitry of FIG. 3 is instantiated by the hardware circuits of the microprocessor 1500 in combination with the machine-readable instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine-readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine-readable instructions and/or operations represented by the flowcharts of FIGS. 9-12.

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCIe bus. Additionally or alternatively, the first bus 1504 may be implemented by any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer-based operations. In other examples, the AL circuitry 1516 also performs floating-point operations. In yet other examples, the AL circuitry 1516 may include first AL circuitry that performs integer-based operations and second AL circuitry that performs floating-point operations. In some examples, the AL circuitry 1516 may be referred to as an Arithmetic Logic Unit (ALU).

The registers 1518 are semiconductor-based structures to store data and/or instructions such as results of one or more of the operations performed by the AL circuitry 1516 of the corresponding core 1502. For example, the registers 1518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure, such as by being distributed throughout the core 1502 to shorten access time. The second bus 1522 may be implemented by at least one of an I2C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages.

The microprocessor 1500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1500, in the same chip package as the microprocessor 1500 and/or in one or more separate packages from the microprocessor 1500.

FIG. 16 is a block diagram of another example implementation of the programmable circuitry 1412 of FIG. 14. In this example, the programmable circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine-readable instructions. However, once configured, the FPGA circuitry 1600 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine-readable instructions represented by the flowchart(s) of FIGS. 9-12 but whose interconnections and logic circuitry are fixed once fabricated), the FPGA circuitry 1600 of the example of FIG. 16 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 9-12. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9-12. As such, the FPGA circuitry 1600 may be configured and/or structured to effectively instantiate some or all of the operations/functions corresponding to the machine-readable instructions of the flowchart(s) of FIGS. 9-12 as dedicated logic circuits to perform the operations/functions corresponding to those software instructions in a dedicated manner analogous to an ASIC. Therefore, the FPGA circuitry 1600 may perform the operations/functions corresponding to the some or all of the machine-readable instructions of FIGS. 9-12 faster than the general-purpose microprocessor can execute the same.

In the example of FIG. 16, the FPGA circuitry 1600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

The FPGA circuitry 1600 of FIG. 16, includes example input/output (I/O) circuitry 1602 to obtain and/or output data to/from example configuration circuitry 1604 and/or external hardware 1606. For example, the configuration circuitry 1604 may be implemented by interface circuitry that may obtain a binary file, which may be implemented by a bit stream, data, and/or machine-readable instructions, to configure the FPGA circuitry 1600, or portion(s) thereof. In some such examples, the configuration circuitry 1604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine-readable instructions of FIGS. 9-12 and/or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the programmable circuitry 1412 of FIG. 14, many other approaches are contemplated. For example, FPGA circuitry may include an on-board CPU, such as one or more of the example CPU 1620 of FIG. 15. Therefore, the programmable circuitry 1412 of FIG. 14 may additionally be implemented by combining at least the example microprocessor 1500 of FIG. 15 and the example FPGA circuitry 1600 of FIG. 16. In some such hybrid examples, one or more cores 1502 of FIG. 15 may execute a first portion of the machine-readable instructions represented by the flowchart(s) of FIGS. 9-12 to perform first operation(s)/function(s), the FPGA circuitry 1600 of FIG. 16 may be configured and/or structured to perform second operation(s)/function(s) corresponding to a second portion of the machine-readable instructions represented by the flowcharts of FIG. 9-12, and/or an ASIC may be configured and/or structured to perform third operation(s)/function(s) corresponding to a third portion of the machine-readable instructions represented by the flowcharts of FIGS. 9-12.

It should be understood that some or all of the circuitry of FIG. 3 may, thus, be instantiated at the same or different times. For example, same and/or different portion(s) of the microprocessor 1500 of FIG. 15 may be programmed to execute portion(s) of machine-readable instructions at the same and/or different times. In some examples, same and/or different portion(s) of the FPGA circuitry 1600 of FIG. 16 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 1500 of FIG. 15 may execute machine-readable instructions in one or more threads executing concurrently and/or in series. In some examples, the FPGA circuitry 1600 of FIG. 16 may be configured and/or structured to carry out operations/functions concurrently and/or in series. Moreover, in some examples, some or all of the circuitry of FIG. 3 may be implemented within one or more virtual machines and/or containers executing on the microprocessor 1500 of FIG. 15.

In some examples, the programmable circuitry 1412 of FIG. 14 may be in one or more packages. For example, the microprocessor 1500 of FIG. 15 and/or the FPGA circuitry 1600 of FIG. 16 may be in one or more packages. In some examples, an XPU may be implemented by the programmable circuitry 1412 of FIG. 14, which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16) in still yet another package.

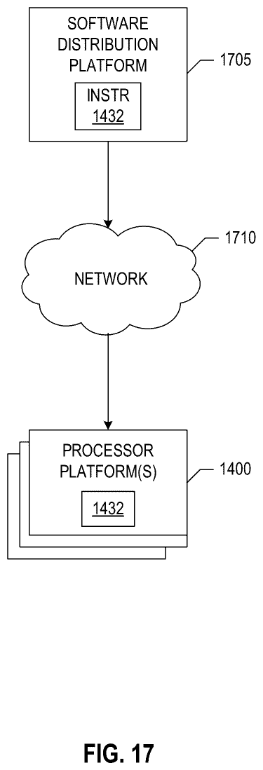

A block diagram illustrating an example software distribution platform 1705 to distribute software such as the example machine-readable instructions 1432 of FIG. 14 to other hardware devices (e.g., hardware devices owned and/or operated by third parties from the owner and/or operator of the software distribution platform) is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine-readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine-readable instructions 1432, which may correspond to the example machine-readable instructions of FIGS. 9-12, as described above. The one or more servers of the example software distribution platform 1705 are in communication with an example network 1710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1432 from the software distribution platform 1705. For example, the software, which may correspond to the example machine-readable instructions of FIG. 9-12, may be downloaded to the example programmable circuitry platform 1400, which is to execute the machine-readable instructions 1432 to implement the clique. In some examples, one or more servers of the software distribution platform 1705 periodically offer, transmit, and/or force updates to the software (e.g., the example machine-readable instructions 1432 of FIG. 14) to ensure improvements, patches, updates, etc., are distributed and applied to the software at the end user devices. Although referred to as software above, the distributed “software” could alternatively be firmware.

FIG. 18 is a block diagram 1800 showing an overview of a configuration for Edge computing, which includes a layer of processing referred to in many of the following examples as an “Edge cloud”. As shown, the Edge cloud 1810 is co-located at an Edge location, such as an access point or base station 1840, a local processing hub 1850, or a central office 1820, and thus may include multiple entities, devices, and equipment instances. The Edge cloud 1810 is located much closer to the endpoint (consumer and producer) data sources 1860 (e.g., autonomous vehicles 1861, user equipment 1862, business and industrial equipment 1863, video capture devices 1864, drones 1865, smart cities and building devices 1866, sensors and IoT devices 1867, etc.) than the cloud data center 1830. Compute, memory, and storage resources which are offered at the edges in the Edge cloud 1810 are critical to providing ultra-low latency response times for services and functions used by the endpoint data sources 1860 as well as reduce network backhaul traffic from the Edge cloud 1810 toward cloud data center 1830 thus improving energy consumption and overall network usages among other benefits.

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate, or, bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge”, “close Edge”, “local Edge”, “middle Edge”, or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

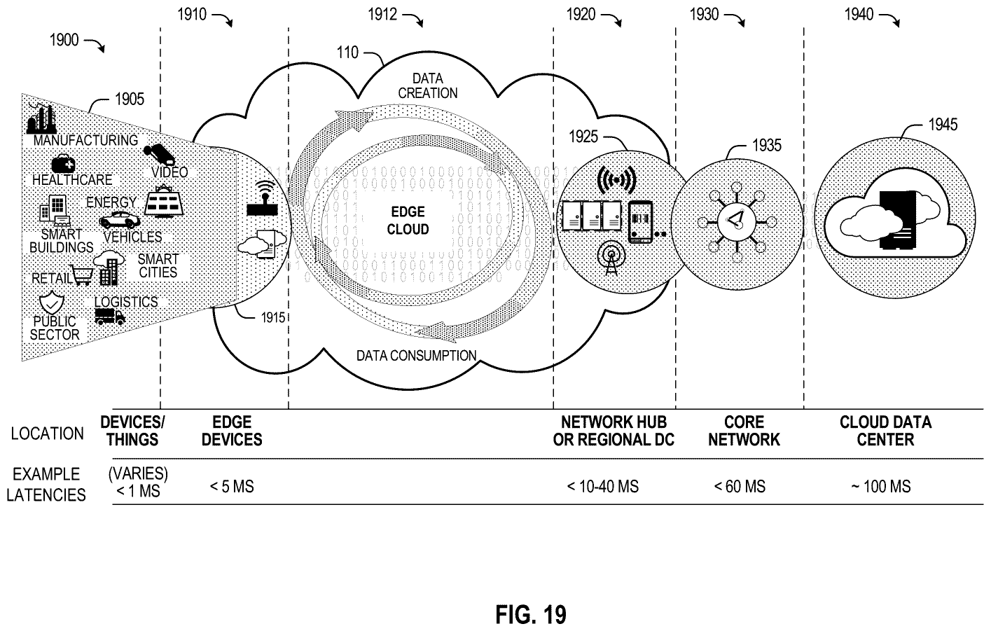

FIG. 19 illustrates operational layers among endpoints, an Edge cloud, and cloud computing environments. Specifically, FIG. 19 depicts examples of computational use cases 1905, utilizing the Edge cloud 1810 among multiple illustrative layers of network computing. The layers begin at an endpoint (devices and things) layer 1900, which accesses the Edge cloud 1810 to conduct data creation, analysis, and data consumption activities. The Edge cloud 1810 may span multiple network layers, such as an Edge devices layer 1910 having gateways, on-premise servers, or network equipment (nodes 1915) located in physically proximate Edge systems; a network access layer 1920, encompassing base stations, radio processing units, network hubs, regional data centers (DC), or local network equipment (equipment 1925); and any equipment, devices, or nodes located therebetween (in layer 1912, not illustrated in detail). The network communications within the Edge cloud 1810 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1900, under 5 ms at the Edge devices layer 1910, to even between 10 to 40 ms when communicating with nodes at the network access layer 1920. Beyond the Edge cloud 1810 are core network 1930 and cloud data center 1940 layers, each with increasing latency (e.g., between 50-60 ms at the core network layer 1930, to 100 or more ms at the cloud data center layer). As a result, operations at a core network data center 1935 or a cloud data center 1945, with latencies of at least 50 to 100 ms or more, will not be able to accomplish many time-critical functions of the use cases 1905. Each of these latency values are provided for purposes of illustration and contrast; it will be understood that the use of other access network mediums and technologies may further reduce the latencies. In some examples, respective portions of the network may be categorized as “close Edge”, “local Edge”, “near Edge”, “middle Edge”, or “far Edge” layers, relative to a network source and destination. For instance, from the perspective of the core network data center 1935 or a cloud data center 1945, a central office or content data network may be considered as being located within a “near Edge” layer (“near” to the cloud, having high latency values when communicating with the devices and endpoints of the use cases 1905), whereas an access point, base station, on-premise server, or network gateway may be considered as located within a “far Edge” layer (“far” from the cloud, having low latency values when communicating with the devices and endpoints of the use cases 1905). It will be understood that other categorizations of a particular network layer as constituting a “close”, “local”, “near”, “middle”, or “far” Edge may be based on latency, distance, number of network hops, or other measurable characteristics, as measured from a source in any of the network layers 1900-1940.

The various use cases 1905 may access resources under usage pressure from incoming streams, due to multiple services utilizing the Edge cloud. To achieve results with low latency, the services executed within the Edge cloud 1810 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement actions to remediate.

Thus, with these variations and service features in mind, Edge computing within the Edge cloud 1810 may provide the ability to serve and respond to multiple applications of the use cases 1905 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because Edge locations may be unmanned and may even need permissioned access (e.g., when housed in a third-party location). Such issues are magnified in the Edge cloud 1810 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud 1810 (network layers 1900-1940), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco”, or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 1810.

As such, the Edge cloud 1810 is formed from network components and functional features operated by and within Edge gateway nodes, Edge aggregation nodes, or other Edge compute nodes among network layers 1910-1930. The Edge cloud 1810 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud 1810 may be envisioned as an “Edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3rd Generation Partnership Project (3GPP) carrier networks.

The network components of the Edge cloud 1810 may be servers, multi-tenant servers, appliance computing devices, and/or any other type of computing devices. For example, the Edge cloud 1810 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input device such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 14. The Edge cloud 1810 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

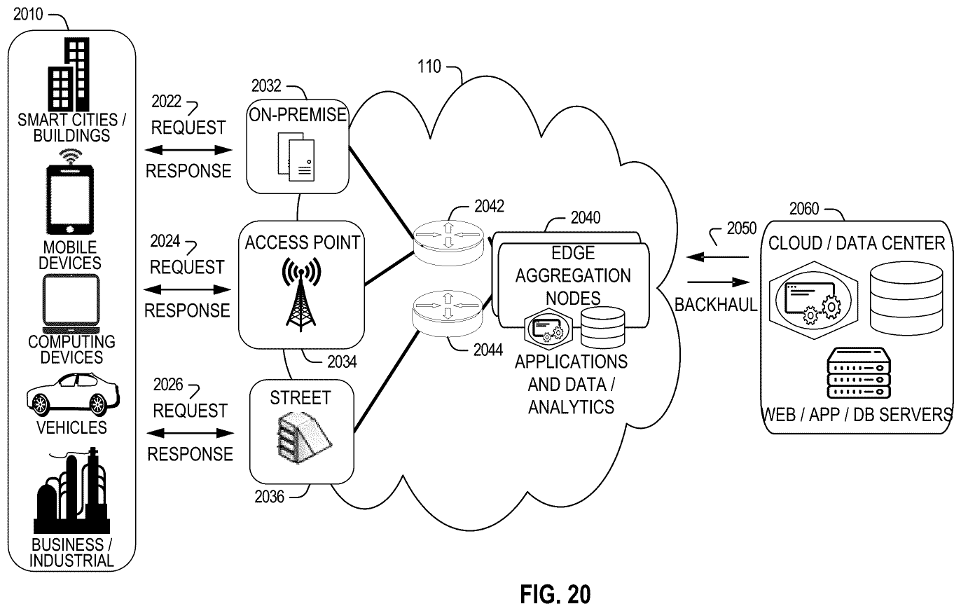

In FIG. 20, various client endpoints 2010 (in the form of mobile devices, computers, autonomous vehicles, business computing equipment, industrial processing equipment) exchange requests and responses that are specific to the type of endpoint network aggregation. For instance, client endpoints 2010 may obtain network access via a wired broadband network, by exchanging requests and responses 2022 through an on-premise network system 2032. Some client endpoints 2010, such as mobile computing devices, may obtain network access via a wireless broadband network, by exchanging requests and responses 2024 through an access point (e.g., a cellular network tower) 2034. Some client endpoints 2010, such as autonomous vehicles may obtain network access for requests and responses 2026 via a wireless vehicular network through a street-located network system 2036. However, regardless of the type of network access, the TSP may deploy aggregation points 2042, 2044 within the Edge cloud 1810 to aggregate traffic and requests. Thus, within the Edge cloud 1810, the TSP may deploy various compute and storage resources, such as at Edge aggregation nodes 2040, to provide requested content. The Edge aggregation nodes 2040 and other systems of the Edge cloud 1810 are connected to a cloud or data center 2060, which uses a backhaul network 2050 to fulfill higher-latency requests from a cloud/data center for websites, applications, database servers, etc. Additional or consolidated instances of the Edge aggregation nodes 2040 and the aggregation points 2042, 2044, including those deployed on a single server framework, may also be present within the Edge cloud 1810 or other areas of the TSP infrastructure.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional objects, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, objects, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the objects referenced by the connection reference and/or relative movement between those objects unless otherwise indicated. As such, connection references do not necessarily infer that two objects are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish objects for ease of understanding the disclosed examples. In some examples, the descriptor “first” may be used to refer to an object in the detailed description, while the same object may be referred to in a claim with a different descriptor such as “second” or “third.” In such instances, it should be understood that such descriptors are used merely for identifying those objects distinctly within the context of the discussion (e.g., within a claim) in which the objects might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real-time” refers to occurrence in a near instantaneous manner recognizing there may be real world delays for computing time, transmission, etc.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit objects such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit objects, a system on chip (SoC), etc.

From the foregoing, it will be appreciated that example systems, apparatus, articles of manufacture, and methods have been disclosed that enable cost effective and time efficient generation of 3D models that use cameras to capture dynamic environments from long ranges. Disclosed systems, apparatus, articles of manufacture, and methods improve the efficiency of using a computing device by implementing cameras that identify pixels with a high probability of belonging to the foreground of an image, compress the pixels into polytopes that can be described using a single TCP/IP frame, and send the frame to a sever in a manner that is both time sensitive and does not interfere with other communications in the clique. Disclosed systems, apparatus, articles of manufacture, and methods improve the efficiency of using a computing device by implementing a server to efficiently determine the intersection of multiple polytopes and forming a 3D model with polycells that have confidence values above a threshold. As such, cliques implemented in accordance with the teachings of this disclosure are both economically scalable and capable of supporting applications that make real-time or substantially real-time inferences. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to model volumetric representations are disclosed herein. Further examples and combinations thereof include the following.

Example 1 includes an apparatus to model a volumetric representation of an object in a scene, the apparatus comprising interface circuitry, machine-readable instructions, and programmable circuitry to at least one of instantiate or execute the machine-readable instructions to form a set of polycells from image data of the scene, a first one of the polycells based on an intersection of (a) a first polytope representative of at least a portion of a first view frustrum corresponding to a first camera, and (b) a second polytope representative of at least a portion of a second view frustrum corresponding to a second camera, determine a probability that the first one of the polycells is at least partially within the object in the scene, and based on comparison of the probability to a threshold, remove the first one of the polycells from the set of polycells to determine an updated set of polycells that model the object.

Example 2 includes the apparatus of example 1, wherein the probability is a first probability that the first one of the polycells is at least partially within the object in the scene, and the first probability is based on a second probability that the first polytope is in a foreground of the scene and a third probability that the second polytope is in the foreground of the scene.

Example 3 includes the apparatus of example 2, wherein to determine the first probability, the programmable circuitry is to determine a product of the second probability and the third probability, determine a cumulative distribution function (CDF) of the product, and compare the CDF to the threshold.

Example 4 includes the apparatus of example 2, wherein the threshold is a first threshold, and the programmable circuitry is to form the first one of the polycells based on a determination that a product of the second probability and the third probability satisfies a second threshold.

Example 5 includes the apparatus of example 1, wherein the programmable circuitry is to form the first one of the polycells based on a bounded volume of four non-orthogonal planes, first and second ones of the four non-orthogonal planes corresponding to the first polytope and third and fourth ones of the four non-orthogonal planes corresponding to the second polytope.

Example 6 includes the apparatus of example 5, wherein the programmable circuitry is to form a matrix of normal vectors representative of orientations of the non-orthogonal planes, multiply the matrix with coordinates of a point in space to determine a product, and determine, based on the product, whether to include the point in the bounded volume.

Example 7 includes the apparatus of example 6, wherein the programmable circuitry is to include the point within the bounded volume in response to a determination that the product is greater than Hesse distances of the planes.

Example 8 includes the apparatus of example 1, wherein the programmable circuitry is to cause a message to be sent to the first camera to provide at least one of a pan instruction, a tilt instruction, or a zoom instruction to the first camera.

Example 9 includes the apparatus of example 1, wherein the programmable circuitry is to obtain a first message from the first camera, the first message including a description of the first polytope, and obtain a second message from the first camera, the second message including a description of the second polytope, the second message obtained after the first message based on a schedule.

Example 10 includes the apparatus of example 9, wherein the programmable circuitry is to form the schedule based on the first camera and the second camera sharing a common field of view.

Example 11 includes an apparatus to characterize an object, the apparatus comprising sensor circuitry to capture an image of a scene, machine-readable instructions, and programmable circuitry to at least one of instantiate or execute the machine-readable instructions to form a bitmask of a portion of the scene based on a first probability that a pixel of the image is in a foreground of the scene, the portion of the scene to include an object, divide the bitmask into a quadrant tree including a plurality of bitmask portions, the quadrant tree organized based on second probabilities of respective ones of the bitmask portions corresponding to the object, and cause the quadrant tree to be transmitted over a network.

Example 12 includes the apparatus of example 11, wherein the pixel is a first pixel, the image includes a plurality of pixels including the first pixel, and the programmable circuitry is to determine the first probability based on a plurality of histograms corresponding respective to the plurality of pixels, a first one of the histograms to represent an intensity of the first pixel over time.

Example 13 includes the apparatus of example 12, wherein the programmable circuitry is to add the first pixel to the bitmask based on comparison of the first probability to a threshold.

Example 14 includes the apparatus of example 11, wherein the programmable circuitry is to truncate the quadrant tree to remove one of the bitmask portions based on comparison of a threshold to a respective one of the second probabilities corresponding to the one of the bitmask portions.

Example 15 includes the apparatus of example 14, wherein the programmable circuitry is to encode the truncated quadrant tree into a message, the message to describe the truncated quadrant tree as a set of squares having x coordinates, y coordinates, and length values.

Example 16 includes the apparatus of example 11, wherein the programmable circuitry is to cause the quadrant tree to be transmitted to a server, and determine, in response to a request from the server, textures for one or more of the bitmask portions of the quadrant tree.

Example 17 includes a non-transitory machine-readable storage medium comprising instructions to cause programmable circuitry to at least form a set of polycells from image data of a scene, a first one of the polycells based on an intersection of (a) a first polytope representative of at least a portion of a first view frustrum corresponding to a first camera, and (b) a second polytope representative of at least a portion of a second view frustrum corresponding to a second camera, determine a probability that the first one of the polycells is at least partially within an object in the scene, and based on comparison of the probability to a threshold, remove the first one of the polycells from the set of polycells to determine an updated set of polycells that model the object.

Example 18 includes the non-transitory machine-readable storage medium of example 17, wherein the probability is a first probability that the first one of the polycells is at least partially within the object in the scene, and the first probability is based on a second probability that the first polytope is in a foreground of the scene and a third probability that the second polytope is in the foreground of the scene.

Example 19 includes the non-transitory machine-readable storage medium of example 18, wherein to determine the first probability, the instructions are to cause the programmable circuitry to determine a product of the second probability and the third probability, determine a cumulative distribution function (CDF) of the product, and compare the CDF to the threshold.

Example 20 includes the non-transitory machine-readable storage medium of example 18, wherein the threshold is a first threshold, and the instructions are to cause the programmable circuitry to form the first one of the polycells based on a determination that a product of the second probability and the third probability satisfies a second threshold.

Example 21 includes the non-transitory machine-readable storage medium of example 17, wherein the instructions are to cause the programmable circuitry to form the first one of the polycells based on a bounded volume of four non-orthogonal planes, first and second ones of the four non-orthogonal planes corresponding to the first polytope and third and fourth ones of the four non-orthogonal planes corresponding to the second polytope.

Example 22 includes the non-transitory machine-readable storage medium of example 21, wherein the instructions are to cause the programmable circuitry to form a matrix of normal vectors representative of orientations of the non-orthogonal planes, multiply the matrix with coordinates of a point in space to determine a product, and determine, based on the product, whether to include the point in the bounded volume.

Example 23 includes the non-transitory machine-readable storage medium of example 22, wherein the instructions are to cause the programmable circuitry to include the point within the bounded volume in response to a determination that the product is greater than Hesse distances of the planes.

Example 24 includes the non-transitory machine-readable storage medium of example 17, wherein the instructions are to cause the programmable circuitry to send a message to the first camera provide at least one of a pan instruction, a tilt instruction, or a zoom instruction to the first camera.

Example 25 includes the non-transitory machine-readable storage medium of example 17, wherein the instructions are to cause the programmable circuitry to obtain a first message from the first camera, the first message including a description of the first polytope, and obtain a second message from the first camera, the second message including a description of the second polytope, the second message to be obtained after the first message based on a schedule.

Example 26 includes the non-transitory machine-readable storage medium of example 25, wherein the programmable circuitry is to form the schedule based on the first camera and the second camera sharing a common field of view.

Example 27 includes a non-transitory machine-readable storage medium comprising instructions to cause programmable circuitry to at least capture an image of a scene, form a bitmask of a portion of the scene based on a first probability that a pixel of the image is in a foreground of the scene, divide the bitmask into a quadrant tree including a plurality of bitmask portions, the quadrant tree organized based on second probabilities of respective ones of the bitmask portions corresponding to an object in the scene, and cause the quadrant tree to be transmitted over a network.

Example 28 includes the non-transitory machine-readable storage medium of example 27, wherein the pixel is a first pixel, the image includes a plurality of pixels including the first pixel, and the instructions are to cause the programmable circuitry to determine the first probability based on a plurality of histograms corresponding respective to the plurality of pixels, a first one of the histograms to map intensity of the first pixel over time.

Example 29 includes the non-transitory machine-readable storage medium of example 28, wherein the instructions are to cause the programmable circuitry to add the first pixel to the bitmask based on comparison of the first probability to a threshold.

Example 30 includes the non-transitory machine-readable storage medium of example 27, wherein the instructions are to cause the programmable circuitry to truncate the quadrant tree to remove one of the bitmask portions based on comparison of a threshold to a respective one of the second probabilities corresponding to the one of the bitmask portions.

Example 31 includes the non-transitory machine-readable storage medium of example 30, wherein the instructions are to cause the programmable circuitry to encode the truncated quadrant tree into a message, the message to describe the truncated quadrant tree as a set of squares having x coordinates, y coordinates, and length values.

Example 32 includes the non-transitory machine-readable storage medium of example 27, wherein the instructions are to cause the programmable circuitry to cause the quadrant tree to be transmitted to a server, and determine, in response to a request from the server, textures for one or more of the bitmask portions of the quadrant tree.

Example 33 includes a method to model volumetric representations of an object in a scene, the method comprising forming a set of polycells from image data of the scene, a first one of the polycells based on an intersection of (a) a first polytope representative of at least a portion of a first view frustrum corresponding to a first camera, and (b) a second polytope representative of at least a portion of a second view frustrum corresponding to a second camera, determining a probability that the first one of the polycells is at least partially within the object in the scene, and based on comparison of the probability to a threshold, removing the first one of the polycells from the set of polycells to determine an updated set of polycells that model the object.

Example 34 includes the method of example 33, wherein the probability is a first probability that the first one of the polycells is at least partially within the object in the scene, and the first probability is based on a second probability that the first polytope is in a foreground of the scene and a third probability that the second polytope is in the foreground of the scene.

Example 35 includes the method of example 34, wherein determining the first probability further includes determining a product of the second probability and the third probability, determining a cumulative distribution function (CDF) of the product, and comparing the CDF to the threshold.

Example 36 includes the method of example 34, wherein the threshold is a first threshold, and the method further includes forming the first one of the polycells based on a determination that a product of the second probability and the third probability satisfies a second threshold.

Example 37 includes the method of example 33, further including forming the first one of the polycells based on a bounded volume of four non-orthogonal planes, first and second ones of the four non-orthogonal planes corresponding to the first polytope and third and fourth ones of the four non-orthogonal planes corresponding to the second polytope.

Example 38 includes the method of example 37, wherein the method further includes forming a matrix of normal vectors representative of orientations of the non-orthogonal planes, multiplying the matrix with coordinates of a point in space to determine a product, and determining, based on the product, whether to include the point in the bounded volume.

Example 39 includes the method of example 38, further including representing the point within the bounded volume in response to a determination that the product is greater than Hesse distances of the planes.

Example 40 includes the method of example 33, further including causing a message to be sent to the first camera to provide at least one of a pan instruction, a tilt instruction, or a zoom instruction to the first camera.

Example 41 includes the method of example 33, further including obtaining a first message from the first camera, the first message including a description of the first polytope, and obtaining a second message from the first camera, the second message including a description of the second polytope, the second message obtained after the first message based on a schedule.

Example 42 includes the method of example 41, further including forming the schedule based on the first camera and the second camera sharing a common field of view.

Example 43 includes a method to characterize an object, the method comprising capturing an image of a scene, forming a bitmask of a portion of the scene based on a first probability that a pixel of the image is in a foreground of the scene, the portion of the scene to include an object, dividing the bitmask into a quadrant tree including a plurality of bitmask portions, the quadrant tree organized based on second probabilities of respective ones of the bitmask portions corresponding to the object, and causing the quadrant tree to be transmitted over a network.

Example 44 includes the method of example 43, wherein the pixel is a first pixel, the image includes a plurality of pixels including the first pixel, and the method further includes determining the first probability based on a plurality of histograms corresponding respective to the plurality of pixels, a first one of the histograms to map an intensity of the first pixel over time.

Example 45 includes the method of example 44, further including adding the first pixel to the bitmask based on comparison of the first probability to a threshold.

Example 46 includes the method of example 43, further including truncating the quadrant tree to remove one of the bitmask portions based on comparison of a threshold to a respective one of the second probabilities corresponding to the one of the bitmask portions.

Example 47 includes the method of example 46, further including encoding the truncated quadrant tree into a message, the message to describe the truncated quadrant tree as a set of squares having x coordinates, y coordinates, and length values.

Example 48 includes the method of example 43, further including causing the quadrant tree to be transmitted to a server, and determining, in response to a request from the server, textures for one or more of the bitmask portions of the quadrant tree.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to model a volumetric representation of an object in a scene, the apparatus comprising:
interface circuitry;
machine-readable instructions; and
programmable circuitry to at least one of instantiate or execute the machine-readable instructions to:
form a set of polycells from image data of the scene, a first one of the polycells based on an intersection of (a) a first polytope representative of at least a portion of a first view frustrum corresponding to a first camera, and (b) a second polytope representative of at least a portion of a second view frustrum corresponding to a second camera;
determine a probability that the first one of the polycells is at least partially within the object in the scene; and
based on comparison of the probability to a threshold, remove the first one of the polycells from the set of polycells to determine an updated set of polycells that model the object.

2. The apparatus of claim 1, wherein the probability is a first probability that the first one of the polycells is at least partially within the object in the scene, and the first probability is based on a second probability that the first polytope is in a foreground of the scene and a third probability that the second polytope is in the foreground of the scene.

3. The apparatus of claim 2, wherein to determine the first probability, the programmable circuitry is to:
determine a product of the second probability and the third probability; and
compare the product to the threshold.

4. The apparatus of claim 2, wherein the threshold is a first threshold, and the programmable circuitry is to form the first one of the polycells based on a determination that a product of the second probability and the third probability satisfies a second threshold.

5. The apparatus of claim 1, wherein the programmable circuitry is to form the first one of the polycells based on a bounded volume of four non-orthogonal planes, first and second ones of the four non-orthogonal planes corresponding to the first polytope and third and fourth ones of the four non-orthogonal planes corresponding to the second polytope.

6. The apparatus of claim 5, wherein the programmable circuitry is to:
form a matrix of normal vectors representative of orientations of the non-orthogonal planes;
multiply the matrix with coordinates of a point in space to determine a product; and
determine, based on the product, whether to include the point in the bounded volume.

7. The apparatus of claim 6, wherein the programmable circuitry is to include the point within the bounded volume in response to a determination that the product is greater than Hesse distances of the planes.

8. The apparatus of claim 1, wherein the programmable circuitry is to cause a message to be sent to the first camera to provide at least one of a pan instruction, a tilt instruction, or a zoom instruction to the first camera.

9. The apparatus of claim 1, wherein the programmable circuitry is to:
obtain a first message from the first camera, the first message including a description of the first polytope; and
obtain a second message from the first camera, the second message including a description of the second polytope, the second message obtained after the first message based on a schedule.

10. The apparatus of claim 9, wherein the programmable circuitry is to form the schedule based on the first camera and the second camera sharing a common field of view.

11. A non-transitory machine-readable storage medium comprising instructions to cause programmable circuitry to at least:
form a set of polycells from image data of a scene, a first one of the polycells based on an intersection of (a) a first polytope representative of at least a portion of a first view frustrum corresponding to a first camera, and (b) a second polytope representative of at least a portion of a second view frustrum corresponding to a second camera;
determine a probability that the first one of the polycells is at least partially within an object in the scene; and
based on comparison of the probability to a threshold, remove the first one of the polycells from the set of polycells to determine an updated set of polycells that model the object.

12. The non-transitory machine-readable storage medium of claim 11, wherein the probability is a first probability that the first one of the polycells is at least partially within the object in the scene, and the first probability is based on a second probability that the first polytope is in a foreground of the scene and a third probability that the second polytope is in the foreground of the scene.

13. The non-transitory machine-readable storage medium of claim 12, wherein to determine the first probability, the instructions are to cause the programmable circuitry to:
determine a product of the second probability and the third probability; and
compare the product to the threshold.

14. The non-transitory machine-readable storage medium of claim 12, wherein the threshold is a first threshold, and the instructions are to cause the programmable circuitry to form the first one of the polycells based on a determination that a product of the second probability and the third probability satisfies a second threshold.

15. The non-transitory machine-readable storage medium of claim 11, wherein the instructions are to cause the programmable circuitry to form the first one of the polycells based on a bounded volume of four non-orthogonal planes, first and second ones of the four non-orthogonal planes corresponding to the first polytope and third and fourth ones of the four non-orthogonal planes corresponding to the second polytope.

16. The non-transitory machine-readable storage medium of claim 15, wherein the instructions are to cause the programmable circuitry to:
form a matrix of normal vectors representative of orientations of the non-orthogonal planes;
multiply the matrix with coordinates of a point in space to determine a product; and
determine, based on the product, whether to include the point in the bounded volume.

17. The non-transitory machine-readable storage medium of claim 16, wherein the instructions are to cause the programmable circuitry to include the point within the bounded volume in response to a determination that the product is greater than Hesse distances of the planes.

18. The non-transitory machine-readable storage medium of claim 11, wherein the instructions are to cause the programmable circuitry to send a message to the first camera provide at least one of a pan instruction, a tilt instruction, or a zoom instruction to the first camera.

19. A method to model volumetric representations of an object in a scene, the method comprising:
forming a set of polycells from image data of the scene, a first one of the polycells based on an intersection of (a) a first polytope representative of at least a portion of a first view frustrum corresponding to a first camera, and (b) a second polytope representative of at least a portion of a second view frustrum corresponding to a second camera;
determining a probability that the first one of the polycells is at least partially within the object in the scene; and
based on comparison of the probability to a threshold, removing the first one of the polycells from the set of polycells to determine an updated set of polycells that model the object.

20. The method of claim 19, wherein the probability is a first probability that the first one of the polycells is at least partially within the object in the scene, and the first probability is based on a second probability that the first polytope is in a foreground of the scene and a third probability that the second polytope is in the foreground of the scene.
